(19) United States
(12) Patent Application Publication
(10) Pub. No.: US 2026/0107203 A1
(43) Pub. Date: Apr. 16, 2026

(54) BEAM FAILURE DETECTION AND RECOVERY FOR L1 MOBILITY

(71) Applicant: InterDigital Patent Holdings, Inc., Wilmington, DE (US)

(72) Inventors: Oumer Teyeb, Montreal (CA); Faris Alfarhan, Montreal (CA); Paul Marinier, Brossard (CA); Dylan Watts, Montreal (CA); Brian Martin, Farnham (GB)

(73) Assignee: InterDigital Patent Holdings, Inc., Wilmington, DE (US)

(21) Appl. No.: 19/116,799

(22) PCT Filed: Sep. 28, 2023
(86) PCT No.: PCT/US2023/034003

§ 371 Date: Mar. 28, 2025

Related U.S. Application Data
(60) Provisional application No. 63/410,728, filed on Sep. 28, 2022.

(51) Int. Cl. H04W 36/08; H04W 36/00

(52) U.S. Cl. CPC H04W 36/08; H04W 36/0058

(57) ABSTRACT

Systems, methods, and instrumentalities are described herein for beam failure detection and recovery for layer 1 (L1) mobility. A wireless transmit/receive unit (WTRU) may be configured to receive configuration information and an indication of at least one condition to perform beam failure recovery (BFR) via the a L1/L2 mobility (LTM) candidate cell. The WTRU may detect a serving cell beam failure. Based on the detection of the serving cell beam failure, the WTRU may determine whether at least one condition to perform BFR via the LTM candidate cell is fulfilled. The WTRU may perform BFR via the LTM candidate cell based on the at least one condition being fulfilled.

### CROSS-REFERENCE TO RELATED APPLICATIONS

This application claims the benefit of Provisional U.S. Patent Application No. 63/410,728, filed Sep. 28, 2022, the disclosure of which is incorporated herein by reference in its entirety.

### BACKGROUND

Mobile communications using wireless communication continue to evolve. A fifth generation may be referred to as 5G. A previous (legacy) generation of mobile communication may be, for example, fourth generation (4G) long term evolution (LTE).

### SUMMARY

Systems, methods, and instrumentalities are described herein for beam failure detection and recovery for layer 1 (L1) mobility.

A wireless transmit/receive unit (WTRU) may be configured to receive configuration information. The configuration information may indicate a L1/L2 mobility (LTM) candidate configuration and a beam failure recovery (BFR) resource configuration. The LTM candidate configuration may indicate an LTM candidate cell. The BFR resource configuration may indicate a resource associated with the LTM candidate cell.

The WTRU may receive an indication of at least one condition to perform BFR via the LTM candidate cell. The at least one condition to perform BFR via the LTM candidate cell may include the BFR being unavailable via a serving cell (e.g., the serving cell having no suitable beam). The at least one condition to perform BFR via the LTM candidate cell may include a beam detected on the LTM candidate being above a threshold or a beam detected on the LTM candidate cell having better radio conditions than a best beam on a serving cell.

The WTRU may detect a serving cell beam failure. Based on the detection of the serving cell beam failure, the WTRU may determine whether at least one condition to perform BFR via the LTM candidate cell is fulfilled. The WTRU may perform BFR via the LTM candidate cell based on the at least one condition being fulfilled. In examples, the BFR performed via the LTM candidate cell includes at least a random access (RA) procedure being started towards the LTM candidate cell using the resource associated with the LTM candidate cell. The BFR performed via the LTM candidate cell may (e.g., may further) include a BFR MAC CE being sent with information of a best beam of the LTM candidate cell. In examples, the WTRU may be (e.g., may be further) configured to perform a measurement on a beam of the LTM candidate cell based on a beam failure detection (BFD) counter being above a threshold.

### BRIEF DESCRIPTION OF THE DRAWINGS

FIG. 1A is a system diagram illustrating an example communications system in which one or more disclosed embodiments may be implemented;

FIG. 1B is a system diagram illustrating an example wireless transmit/receive unit (WTRU) that may be used within the communications system illustrated in FIG. 1A according to an embodiment;

FIG. 1C is a system diagram illustrating an example radio access network (RAN) and an example core network (CN) that may be used within the communications system illustrated in FIG. 1A according to an embodiment;

FIG. 1D is a system diagram illustrating a further example RAN and a further example CN that may be used within the communications system illustrated in FIG. 1A according to an embodiment;

FIG. 2 illustrates an example of a handover procedure in a wireless network

FIG. 3 illustrates an example of a conditional handover (CHO) configuration and execution.

FIG. 4 illustrates an example of a measurement model (e.g., a high-level measurement model).

FIG. 5 illustrates an example of radio link monitoring (RLM) and radio link failure (RLF) detection mechanisms.

FIG. 6 illustrates a high-level overview of a re-establishment procedure.

FIG. 7 illustrates an example of L1/2 inter-cell mobility using carrier aggregation (CA).

FIG. 8 illustrates example feature(s) associated with performing beam failure recovery (BFR).

### DETAILED DESCRIPTION

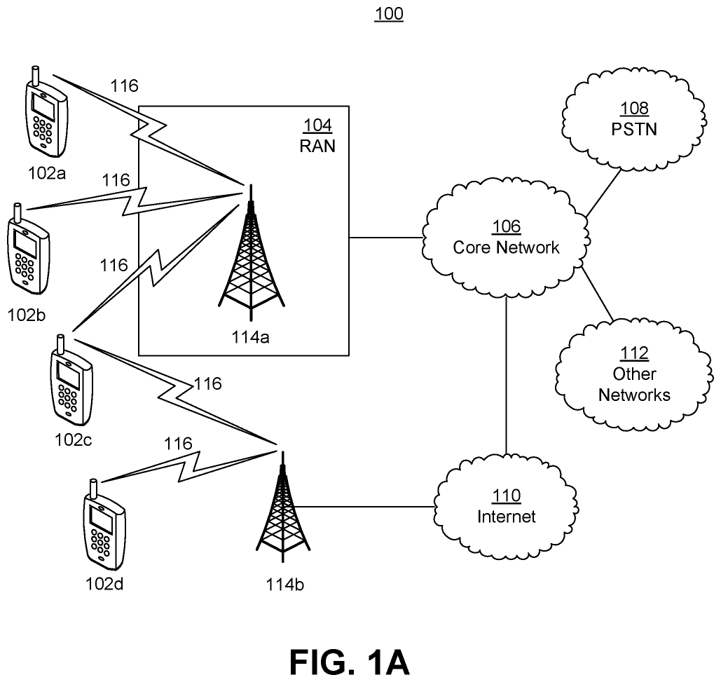

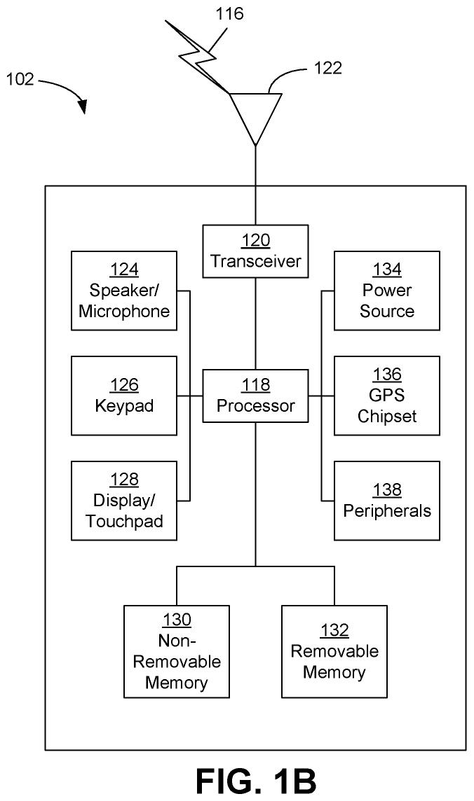

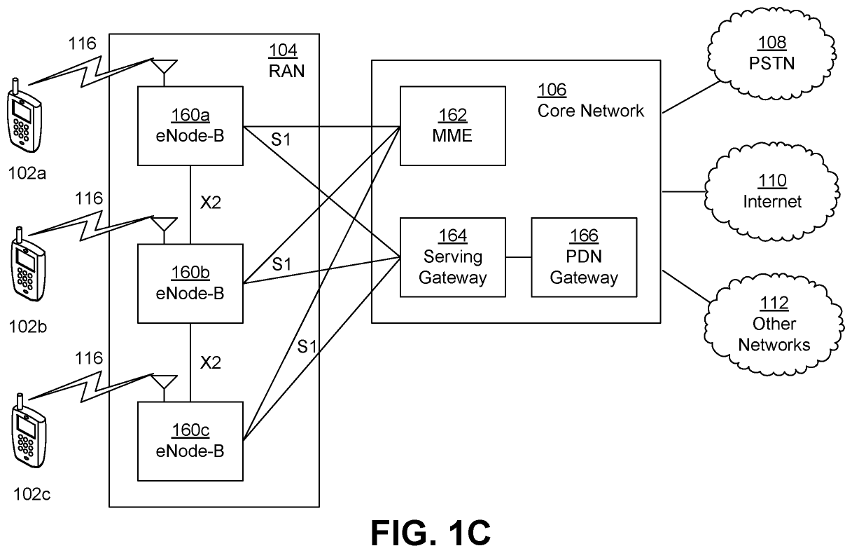

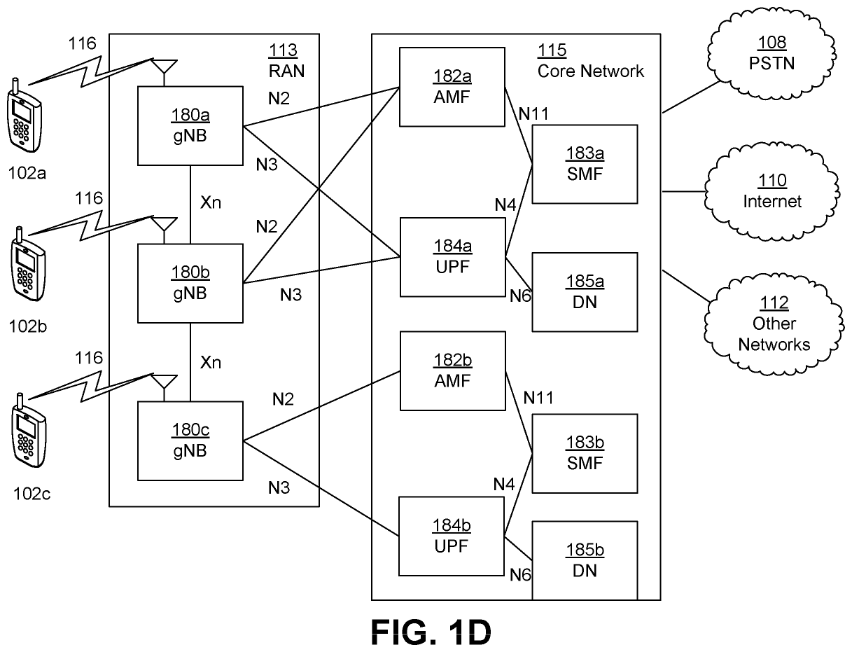

FIG. 1A is a diagram illustrating an example communications system 100 in which one or more disclosed embodiments may be implemented. The communications system 100 may be a multiple access system that provides content, such as voice, data, video, messaging, broadcast, etc., to multiple wireless users. The communications system 100 may enable multiple wireless users to access such content through the sharing of system resources, including wireless bandwidth. For example, the communications systems 100 may employ one or more channel access methods, such as code division multiple access (CDMA), time division multiple access (TDMA), frequency division multiple access (FDMA), orthogonal FDMA (OFDMA), single-carrier FDMA (SC-FDMA), zero-tail unique-word DFT-Spread OFDM (ZT UW DTS-s OFDM), unique word OFDM (UW-OFDM), resource block-filtered OFDM, filter bank multicarrier (FBMC), and the like.

As shown in FIG. 1A, the communications system 100 may include wireless transmit/receive units (WTRUs) 102a, 102b, 102c, 102d, a RAN 104/113, a CN 106/115, a public switched telephone network (PSTN) 108, the Internet 110, and other networks 112, though it will be appreciated that the disclosed embodiments contemplate any number of WTRUs, base stations, networks, and/or network elements. Each of the WTRUs 102a, 102b, 102c, 102d may be any type of device configured to operate and/or communicate in a wireless environment. By way of example, the WTRUs 102a, 102b, 102c, 102d, any of which may be referred to as a “station” and/or a “STA”, may be configured to transmit and/or receive wireless signals and may include a user equipment (UE), a mobile station, a fixed or mobile subscriber unit, a subscription-based unit, a pager, a cellular telephone, a personal digital assistant (PDA), a smartphone, a laptop, a netbook, a personal computer, a wireless sensor, a hotspot or Mi-Fi device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. Any of the WTRUs 102a, 102b, 102c and 102d may be interchangeably referred to as a UE.

The communications systems 100 may also include a base station 114a and/or a base station 114b. Each of the base stations 114a, 114b may be any type of device configured to wirelessly interface with at least one of the WTRUs 102a, 102b, 102c, 102d to facilitate access to one or more communication networks, such as the CN 106/115, the Internet 110, and/or the other networks 112. By way of example, the base stations 114a, 114b may be a base transceiver station (BTS), a Node-B, an eNode B, a Home Node B, a Home eNode B, a gNB, a NR NodeB, a site controller, an access point (AP), a wireless router, and the like. While the base stations 114a, 114b are each depicted as a single element, it will be appreciated that the base stations 114a, 114b may include any number of interconnected base stations and/or network elements.

The base station 114a may be part of the RAN 104/113, which may also include other base stations and/or network elements (not shown), such as a base station controller (BSC), a radio network controller (RNC), relay nodes, etc. The base station 114a and/or the base station 114b may be configured to transmit and/or receive wireless signals on one or more carrier frequencies, which may be referred to as a cell (not shown). These frequencies may be in licensed spectrum, unlicensed spectrum, or a combination of licensed and unlicensed spectrum. A cell may provide coverage for a wireless service to a specific geographical area that may be relatively fixed or that may change over time. The cell may further be divided into cell sectors. For example, the cell associated with the base station 114a may be divided into three sectors. Thus, in one embodiment, the base station 114a may include three transceivers, i.e., one for each sector of the cell. In an embodiment, the base station 114a may employ multiple-input multiple output (MIMO) technology and may utilize multiple transceivers for each sector of the cell. For example, beamforming may be used to transmit and/or receive signals in desired spatial directions.

The base stations 114a, 114b may communicate with one or more of the WTRUs 102a, 102b, 102c, 102d over an air interface 116, which may be any suitable wireless communication link (e.g., radio frequency (RF), microwave, centimeter wave, micrometer wave, infrared (IR), ultraviolet (UV), visible light, etc.). The air interface 116 may be established using any suitable radio access technology (RAT).

More specifically, as noted above, the communications system 100 may be a multiple access system and may employ one or more channel access schemes, such as CDMA, TDMA, FDMA, OFDMA, SC-FDMA, and the like. For example, the base station 114a in the RAN 104/113 and the WTRUs 102a, 102b, 102c may implement a radio technology such as Universal Mobile Telecommunications System (UMTS) Terrestrial Radio Access (UTRA), which may establish the air interface 115/116/117 using wideband CDMA (WCDMA). WCDMA may include communication protocols such as High-Speed Packet Access (HSPA) and/or Evolved HSPA (HSPA+). HSPA may include High-Speed Downlink (DL) Packet Access (HSDPA) and/or High-Speed UL Packet Access (HSUPA).

In an embodiment, the base station 114a and the WTRUs 102a, 102b, 102c may implement a radio technology such as Evolved UMTS Terrestrial Radio Access (E-UTRA), which may establish the air interface 116 using Long Term Evolution (LTE) and/or LTE-Advanced (LTE-A) and/or LTE-Advanced Pro (LTE-A Pro).

In an embodiment, the base station 114a and the WTRUs 102a, 102b, 102c may implement a radio technology such as NR Radio Access, which may establish the air interface 116 using New Radio (NR).

In an embodiment, the base station 114a and the WTRUs 102a, 102b, 102c may implement multiple radio access technologies. For example, the base station 114a and the WTRUs 102a, 102b, 102c may implement LTE radio access and NR radio access together, for instance using dual connectivity (DC) principles. Thus, the air interface utilized by WTRUs 102a, 102b, 102c may be characterized by multiple types of radio access technologies and/or transmissions sent to/from multiple types of base stations (e.g., an eNB and a gNB).

In other embodiments, the base station 114a and the WTRUs 102a, 102b, 102c may implement radio technologies such as IEEE 802.11 (i.e., Wireless Fidelity (WiFi), IEEE 802.16 (i.e., Worldwide Interoperability for Microwave Access (WiMAX)), CDMA2000, CDMA2000 1×, CDMA2000 EV-DO, Interim Standard 2000 (IS-2000), Interim Standard 95 (IS-95), Interim Standard 856 (IS-856), Global System for Mobile communications (GSM), Enhanced Data rates for GSM Evolution (EDGE), GSM EDGE (GERAN), and the like.

The base station 114b in FIG. 1A may be a wireless router, Home Node B, Home eNode B, or access point, for example, and may utilize any suitable RAT for facilitating wireless connectivity in a localized area, such as a place of business, a home, a vehicle, a campus, an industrial facility, an air corridor (e.g., for use by drones), a roadway, and the like. In one embodiment, the base station 114b and the WTRUs 102c, 102d may implement a radio technology such as IEEE 802.11 to establish a wireless local area network (WLAN). In an embodiment, the base station 114b and the WTRUs 102c, 102d may implement a radio technology such as IEEE 802.15 to establish a wireless personal area network (WPAN). In yet another embodiment, the base station 114b and the WTRUs 102c, 102d may utilize a cellular-based RAT (e.g., WCDMA, CDMA2000, GSM, LTE, LTE-A, LTE-A Pro, NR etc.) to establish a picocell or femtocell. As shown in FIG. 1A, the base station 114b may have a direct connection to the Internet 110. Thus, the base station 114b may not be required to access the Internet 110 via the CN 106/115.

The RAN 104/113 may be in communication with the CN 106/115, which may be any type of network configured to provide voice, data, applications, and/or voice over internet protocol (VoIP) services to one or more of the WTRUs 102a, 102b, 102c, 102d. The data may have varying quality of service (QoS) requirements, such as differing throughput requirements, latency requirements, error tolerance requirements, reliability requirements, data throughput requirements, mobility requirements, and the like. The CN 106/115 may provide call control, billing services, mobile location-based services, pre-paid calling, Internet connectivity, video distribution, etc., and/or perform high-level security functions, such as user authentication. Although not shown in FIG. 1A, it will be appreciated that the RAN 104/113 and/or the CN 106/115 may be in direct or indirect communication with other RANs that employ the same RAT as the RAN 104/113 or a different RAT. For example, in addition to being connected to the RAN 104/113, which may be utilizing a NR radio technology, the CN 106/115 may also be in communication with another RAN (not shown) employing a GSM, UMTS, CDMA 2000, WiMAX, E-UTRA, or WiFi radio technology.

The CN 106/115 may also serve as a gateway for the WTRUs 102a, 102b, 102c, 102d to access the PSTN 108, the Internet 110, and/or the other networks 112. The PSTN 108 may include circuit-switched telephone networks that provide plain old telephone service (POTS). The Internet 110 may include a global system of interconnected computer networks and devices that use common communication protocols, such as the transmission control protocol (TCP), user datagram protocol (UDP) and/or the internet protocol (IP) in the TCP/IP internet protocol suite. The networks 112 may include wired and/or wireless communications networks owned and/or operated by other service providers. For example, the networks 112 may include another CN connected to one or more RANs, which may employ the same RAT as the RAN 104/113 or a different RAT.

Some or all of the WTRUs 102a, 102b, 102c, 102d in the communications system 100 may include multi-mode capabilities (e.g., the WTRUs 102a, 102b, 102c, 102d may include multiple transceivers for communicating with different wireless networks over different wireless links). For example, the WTRU 102c shown in FIG. 1A may be configured to communicate with the base station 114a, which may employ a cellular-based radio technology, and with the base station 114b, which may employ an IEEE 802 radio technology.

FIG. 1B is a system diagram illustrating an example WTRU 102. As shown in FIG. 1B, the WTRU 102 may include a processor 118, a transceiver 120, a transmit/receive element 122, a speaker/microphone 124, a keypad 126, a display/touchpad 128, non-removable memory 130, removable memory 132, a power source 134, a global positioning system (GPS) chipset 136, and/or other peripherals 138, among others. It will be appreciated that the WTRU 102 may include any sub-combination of the foregoing elements while remaining consistent with an embodiment.

The processor 118 may be a general purpose processor, a special purpose processor, a conventional processor, a digital signal processor (DSP), a plurality of microprocessors, one or more microprocessors in association with a DSP core, a controller, a microcontroller, Application Specific Integrated Circuits (ASICs), Field Programmable Gate Arrays (FPGAs) circuits, any other type of integrated circuit (IC), a state machine, and the like. The processor 118 may perform signal coding, data processing, power control, input/output processing, and/or any other functionality that enables the WTRU 102 to operate in a wireless environment. The processor 118 may be coupled to the transceiver 120, which may be coupled to the transmit/receive element 122. While FIG. 1B depicts the processor 118 and the transceiver 120 as separate components, it will be appreciated that the processor 118 and the transceiver 120 may be integrated together in an electronic package or chip.

The transmit/receive element 122 may be configured to transmit signals to, or receive signals from, a base station (e.g., the base station 114a) over the air interface 116. For example, in one embodiment, the transmit/receive element 122 may be an antenna configured to transmit and/or receive RF signals. In an embodiment, the transmit/receive element 122 may be an emitter/detector configured to transmit and/or receive IR, UV, or visible light signals, for example. In yet another embodiment, the transmit/receive element 122 may be configured to transmit and/or receive both RF and light signals. It will be appreciated that the transmit/receive element 122 may be configured to transmit and/or receive any combination of wireless signals.

Although the transmit/receive element 122 is depicted in FIG. 1B as a single element, the WTRU 102 may include any number of transmit/receive elements 122. More specifically, the WTRU 102 may employ MIMO technology. Thus, in one embodiment, the WTRU 102 may include two or more transmit/receive elements 122 (e.g., multiple antennas) for transmitting and receiving wireless signals over the air interface 116.

The transceiver 120 may be configured to modulate the signals that are to be transmitted by the transmit/receive element 122 and to demodulate the signals that are received by the transmit/receive element 122. As noted above, the WTRU 102 may have multi-mode capabilities. Thus, the transceiver 120 may include multiple transceivers for enabling the WTRU 102 to communicate via multiple RATs, such as NR and IEEE 802.11, for example.

The processor 118 of the WTRU 102 may be coupled to, and may receive user input data from, the speaker/microphone 124, the keypad 126, and/or the display/touchpad 128 (e.g., a liquid crystal display (LCD) display unit or organic light-emitting diode (OLED) display unit). The processor 118 may also output user data to the speaker/microphone 124, the keypad 126, and/or the display/touchpad 128. In addition, the processor 118 may access information from, and store data in, any type of suitable memory, such as the non-removable memory 130 and/or the removable memory 132. The non-removable memory 130 may include random-access memory (RAM), read-only memory (ROM), a hard disk, or any other type of memory storage device. The removable memory 132 may include a subscriber identity module (SIM) card, a memory stick, a secure digital (SD) memory card, and the like. In other embodiments, the processor 118 may access information from, and store data in, memory that is not physically located on the WTRU 102, such as on a server or a home computer (not shown).

The processor 118 may receive power from the power source 134, and may be configured to distribute and/or control the power to the other components in the WTRU 102. The power source 134 may be any suitable device for powering the WTRU 102. For example, the power source 134 may include one or more dry cell batteries (e.g., nickel-cadmium (NiCd), nickel-zinc (NiZn), nickel metal hydride (NiMH), lithium-ion (Li-ion), etc.), solar cells, fuel cells, and the like.

The processor 118 may also be coupled to the GPS chipset 136, which may be configured to provide location information (e.g., longitude and latitude) regarding the current location of the WTRU 102. In addition to, or in lieu of, the information from the GPS chipset 136, the WTRU 102 may receive location information over the air interface 116 from a base station (e.g., base stations 114a, 114b) and/or determine its location based on the timing of the signals being received from two or more nearby base stations. It will be appreciated that the WTRU 102 may acquire location information by way of any suitable location-determination method while remaining consistent with an embodiment.

The processor 118 may further be coupled to other peripherals 138, which may include one or more software and/or hardware modules that provide additional features, functionality and/or wired or wireless connectivity. For example, the peripherals 138 may include an accelerometer, an e-compass, a satellite transceiver, a digital camera (for photographs and/or video), a universal serial bus (USB) port, a vibration device, a television transceiver, a hands free headset, a Bluetooth® module, a frequency modulated (FM) radio unit, a digital music player, a media player, a video game player module, an Internet browser, a Virtual Reality and/or Augmented Reality (VR/AR) device, an activity tracker, and the like. The peripherals 138 may include one or more sensors, the sensors may be one or more of a gyroscope, an accelerometer, a hall effect sensor, a magnetometer, an orientation sensor, a proximity sensor, a temperature sensor, a time sensor; a geolocation sensor; an altimeter, a light sensor, a touch sensor, a magnetometer, a barometer, a gesture sensor, a biometric sensor, and/or a humidity sensor.

The WTRU 102 may include a full duplex radio for which transmission and reception of some or all of the signals (e.g., associated with particular subframes for both the UL (e.g., for transmission) and downlink (e.g., for reception) may be concurrent and/or simultaneous. The full duplex radio may include an interference management unit to reduce and or substantially eliminate self-interference via either hardware (e.g., a choke) or signal processing via a processor (e.g., a separate processor (not shown) or via processor 118). In an embodiment, the WRTU 102 may include a half-duplex radio for which transmission and reception of some or all of the signals (e.g., associated with particular subframes for either the UL (e.g., for transmission) or the downlink (e.g., for reception)).

FIG. 1C is a system diagram illustrating the RAN 104 and the CN 106 according to an embodiment. As noted above, the RAN 104 may employ an E-UTRA radio technology to communicate with the WTRUs 102a, 102b, 102c over the air interface 116. The RAN 104 may also be in communication with the CN 106.

The RAN 104 may include eNode-Bs 160a, 160b, 160c, though it will be appreciated that the RAN 104 may include any number of eNode-Bs while remaining consistent with an embodiment. The eNode-Bs 160a, 160b, 160c may each include one or more transceivers for communicating with the WTRUs 102a, 102b, 102c over the air interface 116. In one embodiment, the eNode-Bs 160a, 160b, 160c may implement MIMO technology. Thus, the eNode-B 160a, for example, may use multiple antennas to transmit wireless signals to, and/or receive wireless signals from, the WTRU 102a.

Each of the eNode-Bs 160a, 160b, 160c may be associated with a particular cell (not shown) and may be configured to handle radio resource management decisions, handover decisions, scheduling of users in the UL and/or DL, and the like. As shown in FIG. 1C, the eNode-Bs 160a, 160b, 160c may communicate with one another over an X2 interface.

The CN 106 shown in FIG. 1C may include a mobility management entity (MME) 162, a serving gateway (SGW) 164, and a packet data network (PDN) gateway (or PGW) 166. While each of the foregoing elements are depicted as part of the CN 106, it will be appreciated that any of these elements may be owned and/or operated by an entity other than the CN operator.

The MME 162 may be connected to each of the eNode-Bs 162a, 162b, 162c in the RAN 104 via an S1 interface and may serve as a control node. For example, the MME 162 may be responsible for authenticating users of the WTRUs 102a, 102b, 102c, bearer activation/deactivation, selecting a particular serving gateway during an initial attach of the WTRUs 102a, 102b, 102c, and the like. The MME 162 may provide a control plane function for switching between the RAN 104 and other RANs (not shown) that employ other radio technologies, such as GSM and/or WCDMA.

The SGW 164 may be connected to each of the eNode Bs 160a, 160b, 160c in the RAN 104 via the S1 interface. The SGW 164 may generally route and forward user data packets to/from the WTRUs 102a, 102b, 102c. The SGW 164 may perform other functions, such as anchoring user planes during inter-eNode B handovers, triggering paging when DL data is available for the WTRUs 102a, 102b, 102c, managing and storing contexts of the WTRUs 102a, 102b, 102c, and the like.

The SGW 164 may be connected to the PGW 166, which may provide the WTRUs 102a, 102b, 102c with access to packet-switched networks, such as the Internet 110, to facilitate communications between the WTRUs 102a, 102b, 102c and IP-enabled devices.

The CN 106 may facilitate communications with other networks. For example, the CN 106 may provide the WTRUs 102a, 102b, 102c with access to circuit-switched networks, such as the PSTN 108, to facilitate communications between the WTRUs 102a, 102b, 102c and traditional land-line communications devices. For example, the CN 106 may include, or may communicate with, an IP gateway (e.g., an IP multimedia subsystem (IMS) server) that serves as an interface between the CN 106 and the PSTN 108. In addition, the CN 106 may provide the WTRUs 102a, 102b, 102c with access to the other networks 112, which may include other wired and/or wireless networks that are owned and/or operated by other service providers.

Although the WTRU is described in FIGS. 1A-1D as a wireless terminal, it is contemplated that in certain representative embodiments that such a terminal may use (e.g., temporarily or permanently) wired communication interfaces with the communication network.

In representative embodiments, the other network 112 may be a WLAN.

A WLAN in Infrastructure Basic Service Set (BSS) mode may have an Access Point (AP) for the BSS and one or more stations (STAs) associated with the AP. The AP may have an access or an interface to a Distribution System (DS) or another type of wired/wireless network that carries traffic in to and/or out of the BSS. Traffic to STAs that originates from outside the BSS may arrive through the AP and may be delivered to the STAs. Traffic originating from STAs to destinations outside the BSS may be sent to the AP to be delivered to respective destinations. Traffic between STAs within the BSS may be sent through the AP, for example, where the source STA may send traffic to the AP and the AP may deliver the traffic to the destination STA. The traffic between STAs within a BSS may be considered and/or referred to as peer-to-peer traffic. The peer-to-peer traffic may be sent between (e.g., directly between) the source and destination STAs with a direct link setup (DLS). In certain representative embodiments, the DLS may use an 802.11e DLS or an 802.11z tunneled DLS (TDLS). A WLAN using an Independent BSS (IBSS) mode may not have an AP, and the STAs (e.g., all of the STAs) within or using the IBSS may communicate directly with each other. The IBSS mode of communication may sometimes be referred to herein as an “ad-hoc” mode of communication.

When using the 802.11ac infrastructure mode of operation or a similar mode of operations, the AP may transmit a beacon on a fixed channel, such as a primary channel. The primary channel may be a fixed width (e.g., 20 MHz wide bandwidth) or a dynamically set width via signaling. The primary channel may be the operating channel of the BSS and may be used by the STAs to establish a connection with the AP. In certain representative embodiments, Carrier Sense Multiple Access with Collision Avoidance (CSMA/CA) may be implemented, for example in in 802.11 systems. For CSMA/CA, the STAs (e.g., every STA), including the AP, may sense the primary channel. If the primary channel is sensed/detected and/or determined to be busy by a particular STA, the particular STA may back off. One STA (e.g., only one station) may transmit at any given time in a given BSS.

High Throughput (HT) STAs may use a 40 MHz wide channel for communication, for example, via a combination of the primary 20 MHz channel with an adjacent or nonadjacent 20 MHz channel to form a 40 MHz wide channel.

Very High Throughput (VHT) STAs may support 20 MHz, 40 MHz, 80 MHz, and/or 160 MHz wide channels. The 40 MHz, and/or 80 MHz, channels may be formed by combining contiguous 20 MHz channels. A 160 MHz channel may be formed by combining 8 contiguous 20 MHz channels, or by combining two non-contiguous 80 MHz channels, which may be referred to as an 80+80 configuration. For the 80+80 configuration, the data, after channel encoding, may be passed through a segment parser that may divide the data into two streams. Inverse Fast Fourier Transform (IFFT) processing, and time domain processing, may be done on each stream separately. The streams may be mapped on to the two 80 MHz channels, and the data may be transmitted by a transmitting STA. At the receiver of the receiving STA, the above described operation for the 80+80 configuration may be reversed, and the combined data may be sent to the Medium Access Control (MAC).

Sub 1 GHz modes of operation are supported by 802.11af and 802.11ah. The channel operating bandwidths, and carriers, are reduced in 802.11af and 802.11ah relative to those used in 802.11n, and 802.11ac. 802.11af supports 5 MHz, 10 MHz and 20 MHz bandwidths in the TV White Space (TVWS) spectrum, and 802.11ah supports 1 MHz, 2 MHz, 4 MHz, 8 MHz, and 16 MHz bandwidths using non-TVWS spectrum. According to a representative embodiment, 802.11ah may support Meter Type Control/Machine-Type Communications, such as MTC devices in a macro coverage area. MTC devices may have certain capabilities, for example, limited capabilities including support for (e.g., only support for) certain and/or limited bandwidths. The MTC devices may include a battery with a battery life above a threshold (e.g., to maintain a very long battery life).

WLAN systems, which may support multiple channels, and channel bandwidths, such as 802.11n, 802.11ac, 802.11af, and 802.11ah, include a channel which may be designated as the primary channel. The primary channel may have a bandwidth equal to the largest common operating bandwidth supported by all STAs in the BSS. The bandwidth of the primary channel may be set and/or limited by a STA, from among all STAs in operating in a BSS, which supports the smallest bandwidth operating mode. In the example of 802.11ah, the primary channel may be 1 MHz wide for STAs (e.g., MTC type devices) that support (e.g., only support) a 1 MHz mode, even if the AP, and other STAs in the BSS support 2 MHz, 4 MHz, 8 MHz, 16 MHz, and/or other channel bandwidth operating modes. Carrier sensing and/or Network Allocation Vector (NAV) settings may depend on the status of the primary channel. If the primary channel is busy, for example, due to a STA (which supports only a 1 MHz operating mode), transmitting to the AP, the entire available frequency bands may be considered busy even though a majority of the frequency bands remains idle and may be available.

In the United States, the available frequency bands, which may be used by 802.11ah, are from 902 MHz to 928 MHz. In Korea, the available frequency bands are from 917.5 MHz to 923.5 MHz. In Japan, the available frequency bands are from 916.5 MHz to 927.5 MHz. The total bandwidth available for 802.11ah is 6 MHz to 26 MHz depending on the country code.

FIG. 1D is a system diagram illustrating the RAN 113 and the CN 115 according to an embodiment. As noted above, the RAN 113 may employ an NR radio technology to communicate with the WTRUs 102a, 102b, 102c over the air interface 116. The RAN 113 may also be in communication with the CN 115.

The RAN 113 may include gNBs 180a, 180b, 180c, though it will be appreciated that the RAN 113 may include any number of gNBs while remaining consistent with an embodiment. The gNBs 180a, 180b, 180c may each include one or more transceivers for communicating with the WTRUs 102a, 102b, 102c over the air interface 116. In one embodiment, the gNBs 180a, 180b, 180c may implement MIMO technology. For example, gNBs 180a, 108b may utilize beamforming to transmit signals to and/or receive signals from the gNBs 180a, 180b, 180c. Thus, the gNB 180a, for example, may use multiple antennas to transmit wireless signals to, and/or receive wireless signals from, the WTRU 102a. In an embodiment, the gNBs 180a, 180b, 180c may implement carrier aggregation technology. For example, the gNB 180a may transmit multiple component carriers to the WTRU 102a (not shown). A subset of these component carriers may be on unlicensed spectrum while the remaining component carriers may be on licensed spectrum. In an embodiment, the gNBs 180a, 180b, 180c may implement Coordinated Multi-Point (CoMP) technology. For example, WTRU 102a may receive coordinated transmissions from gNB 180a and gNB 180b (and/or gNB 180c).

The WTRUs 102a, 102b, 102c may communicate with gNBs 180a, 180b, 180c using transmissions associated with a scalable numerology. For example, the OFDM symbol spacing and/or OFDM subcarrier spacing may vary for different transmissions, different cells, and/or different portions of the wireless transmission spectrum. The WTRUs 102a, 102b, 102c may communicate with gNBs 180a, 180b, 180c using subframe or transmission time intervals (TTIs) of various or scalable lengths (e.g., containing varying number of OFDM symbols and/or lasting varying lengths of absolute time).

The gNBs 180a, 180b, 180c may be configured to communicate with the WTRUs 102a, 102b, 102c in a standalone configuration and/or a non-standalone configuration. In the standalone configuration, WTRUs 102a, 102b, 102c may communicate with gNBs 180a, 180b, 180c without also accessing other RANs (e.g., such as eNode-Bs 160a, 160b, 160c). In the standalone configuration, WTRUs 102a, 102b, 102c may utilize one or more of gNBs 180a, 180b, 180c as a mobility anchor point. In the standalone configuration, WTRUs 102a, 102b, 102c may communicate with gNBs 180a, 180b, 180c using signals in an unlicensed band. In a non-standalone configuration WTRUs 102a, 102b, 102c may communicate with/connect to gNBs 180a, 180b, 180c while also communicating with/connecting to another RAN such as eNode-Bs 160a, 160b, 160c. For example, WTRUs 102a, 102b, 102c may implement DC principles to communicate with one or more gNBs 180a, 180b, 180c and one or more eNode-Bs 160a, 160b, 160c substantially simultaneously. In the non-standalone configuration, eNode-Bs 160a, 160b, 160c may serve as a mobility anchor for WTRUs 102a, 102b, 102c and gNBs 180a, 180b, 180c may provide additional coverage and/or throughput for servicing WTRUs 102a, 102b, 102c.

Each of the gNBs 180a, 180b, 180c may be associated with a particular cell (not shown) and may be configured to handle radio resource management decisions, handover decisions, scheduling of users in the UL and/or DL, support of network slicing, dual connectivity, interworking between NR and E-UTRA, routing of user plane data towards User Plane Function (UPF) 184a, 184b, routing of control plane information towards Access and Mobility Management Function (AMF) 182a, 182b and the like. As shown in FIG. 1D, the gNBs 180a, 180b, 180c may communicate with one another over an Xn interface.

The CN 115 shown in FIG. 1D may include at least one AMF 182a, 182b, at least one UPF 184a, 184b, at least one Session Management Function (SMF) 183a, 183b, and possibly a Data Network (DN) 185a, 185b. While each of the foregoing elements are depicted as part of the CN 115, it will be appreciated that any of these elements may be owned and/or operated by an entity other than the CN operator.

The AMF 182a, 182b may be connected to one or more of the gNBs 180a, 180b, 180c in the RAN 113 via an N2 interface and may serve as a control node. For example, the AMF 182a, 182b may be responsible for authenticating users of the WTRUs 102a, 102b, 102c, support for network slicing (e.g., handling of different PDU sessions with different requirements), selecting a particular SMF 183a, 183b, management of the registration area, termination of NAS signaling, mobility management, and the like. Network slicing may be used by the AMF 182a, 182b in order to customize CN support for WTRUs 102a, 102b, 102c based on the types of services being utilized WTRUs 102a, 102b, 102c. For example, different network slices may be established for different use cases such as services relying on ultra-reliable low latency (URLLC) access, services relying on enhanced massive mobile broadband (eMBB) access, services for machine type communication (MTC) access, and/or the like. The AMF 162 may provide a control plane function for switching between the RAN 113 and other RANs (not shown) that employ other radio technologies, such as LTE, LTE-A, LTE-A Pro, and/or non-3GPP access technologies such as WiFi.

The SMF 183a, 183b may be connected to an AMF 182a, 182b in the CN 115 via an N11 interface. The SMF 183a, 183b may also be connected to a UPF 184a, 184b in the CN 115 via an N4 interface. The SMF 183a, 183b may select and control the UPF 184a, 184b and configure the routing of traffic through the UPF 184a, 184b. The SMF 183a, 183b may perform other functions, such as managing and allocating UE IP address, managing PDU sessions, controlling policy enforcement and QoS, providing downlink data notifications, and the like. A PDU session type may be IP-based, non-IP based, Ethernet-based, and the like.

The UPF 184a, 184b may be connected to one or more of the gNBs 180a, 180b, 180c in the RAN 113 via an N3 interface, which may provide the WTRUs 102a, 102b, 102c with access to packet-switched networks, such as the Internet 110, to facilitate communications between the WTRUs 102a, 102b, 102c and IP-enabled devices. The UPF 184, 184b may perform other functions, such as routing and forwarding packets, enforcing user plane policies, supporting multi-homed PDU sessions, handling user plane QoS, buffering downlink packets, providing mobility anchoring, and the like.

The CN 115 may facilitate communications with other networks. For example, the CN 115 may include, or may communicate with, an IP gateway (e.g., an IP multimedia subsystem (IMS) server) that serves as an interface between the CN 115 and the PSTN 108. In addition, the CN 115 may provide the WTRUs 102a, 102b, 102c with access to the other networks 112, which may include other wired and/or wireless networks that are owned and/or operated by other service providers. In one embodiment, the WTRUs 102a, 102b, 102c may be connected to a local Data Network (DN) 185a, 185b through the UPF 184a, 184b via the N3 interface to the UPF 184a, 184b and an N6 interface between the UPF 184a, 184b and the DN 185a, 185b.

In view of FIGS. 1A-1D, and the corresponding description of FIGS. 1A-1D, one or more, or all, of the functions described herein with regard to one or more of: WTRU 102a-d, Base Station 114a-b, eNode-B 160a-c, MME 162, SGW 164, PGW 166, gNB 180a-c, AMF 182a-b, UPF 184a-b, SMF 183a-b, DN 185a-b, and/or any other device(s) described herein, may be performed by one or more emulation devices (not shown). The emulation devices may be one or more devices configured to emulate one or more, or all, of the functions described herein. For example, the emulation devices may be used to test other devices and/or to simulate network and/or WTRU functions.

The emulation devices may be designed to implement one or more tests of other devices in a lab environment and/or in an operator network environment. For example, the one or more emulation devices may perform the one or more, or all, functions while being fully or partially implemented and/or deployed as part of a wired and/or wireless communication network in order to test other devices within the communication network. The one or more emulation devices may perform the one or more, or all, functions while being temporarily implemented/deployed as part of a wired and/or wireless communication network. The emulation device may be directly coupled to another device for purposes of testing and/or may performing testing using over-the-air wireless communications.

The one or more emulation devices may perform the one or more, including all, functions while not being implemented/deployed as part of a wired and/or wireless communication network. For example, the emulation devices may be utilized in a testing scenario in a testing laboratory and/or a non-deployed (e.g., testing) wired and/or wireless communication network in order to implement testing of one or more components. The one or more emulation devices may be test equipment. Direct RF coupling and/or wireless communications via RF circuitry (e.g., which may include one or more antennas) may be used by the emulation devices to transmit and/or receive data.

Reference to a timer herein may refer to determination of a time or determination of a period of time. Reference to a timer expiration herein may refer to determining that the time has occurred or that the period of time has expired. Reference to a timer herein may refer to a time, a time period, tracking the time, tracking the period of time, etc. Reference to a legacy technology or legacy handover, may indicate a legacy technology such as LTE compared to NR, or, a legacy version of a technology, for example an earlier version/release of a technology (e.g., earlier NR release) compared to a later version/release of the technology (e.g., later NR release).

Systems, methods, and instrumentalities are described herein for beam failure detection and recovery for layer 1 (L1) mobility.

A wireless transmit/receive unit (WTRU) may be configured to receive configuration information. The configuration information may indicate a L1/L2 mobility (LTM) candidate configuration and a beam failure recovery (BFR) resource configuration. The LTM candidate configuration may indicate an LTM candidate cell. The BFR resource configuration may indicate a resource associated with the LTM candidate cell.

The WTRU may receive an indication of at least one condition to perform BFR via the LTM candidate cell. The at least one condition to perform BFR via the LTM candidate cell may include the BFR being unavailable via a serving cell (e.g., the serving cell having no suitable beam). The at least one condition to perform BFR via the LTM candidate cell may include a beam detected on the LTM candidate being above a threshold or a beam detected on the LTM candidate cell having better radio conditions than a best beam on a serving cell.

The WTRU may detect a serving cell beam failure. Based on the detection of the serving cell beam failure, the WTRU may determine whether at least one condition to perform BFR via the LTM candidate cell is fulfilled. The WTRU may perform BFR via the LTM candidate cell based on the at least one condition being fulfilled. In examples, the BFR performed via the LTM candidate cell includes at least a random access (RA) procedure being started towards the LTM candidate cell using the resource associated with the LTM candidate cell. The BFR performed via the LTM candidate cell may (e.g., may further) include a BFR MAC CE being sent with information of a best beam of the LTM candidate cell. In examples, the WTRU may be (e.g., may be further) configured to perform a measurement on a beam of the LTM candidate cell based on a beam failure detection (BFD) counter being above a threshold.

A WTRU may be configured to indicate beams from candidate cells (e.g., non-serving cells) during beam failure recovery that satisfy one or more conditions (e.g., absolute or relative thresholds, as compared to the beams of the cells where beam failure was detected). A WTRU may, if beam failure is detected, be configured to perform measurements on candidate cells and/or to change the behavior of one or more measurements that the WTRU may have been performing. A WTRU may be configured to perform BFR via candidate cells depending on one or more conditions (e.g., no suitable beam on the failed cell, beams on candidate cells in excellent conditions, etc.). A WTRU may be configured to perform beam failure recovery in a phased fashion (e.g., first attempt, second attempt, etc.). For example, a WTRU may attempt (e.g., first attempt) to perform a BFR (e.g., a first BFR) via the serving cell where beam failure was detected. The WTRU may attempt to perform a BFR (e.g., a second BFR) via another serving cell or a candidate cell if the first attempted beam failure recovery fails (e.g., or takes too long), and so on.

The term special cell (SpCell) may refer to a primary cell (PCell) of a master cell group (MCG) or a primary secondary cell group (SCG) cell (PSCell) of the SCG, for example, depending on whether the medium access control (MAC) entity is associated with the MCG or the SCG.

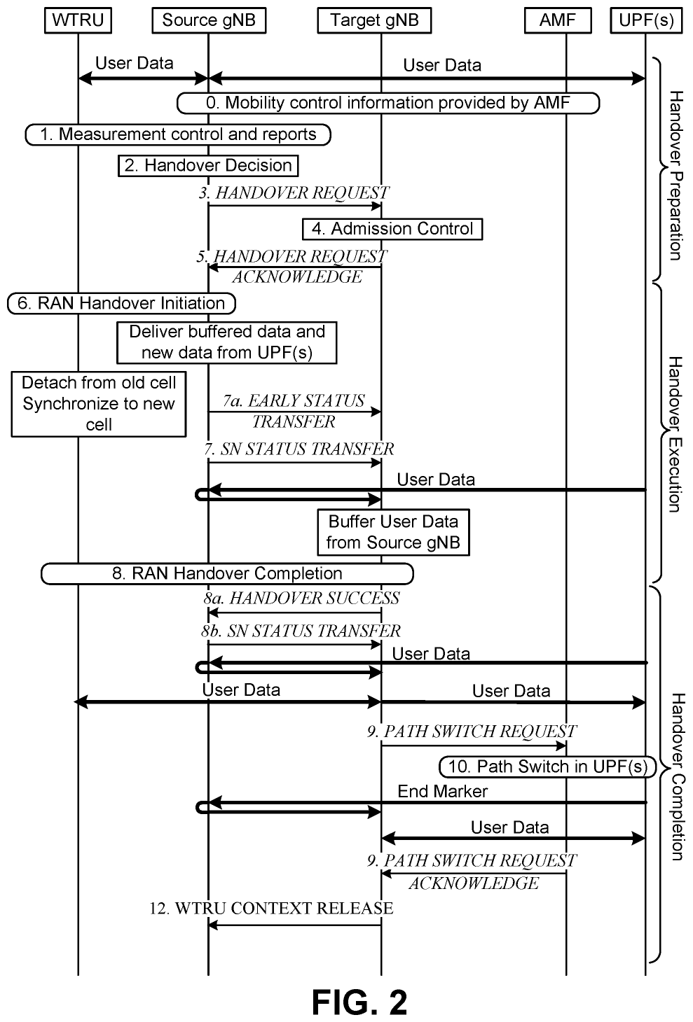

FIG. 2 illustrates an example of a handover procedure in a wireless network (e.g., NR). At 0, the WTRU context within the source gNB may include information regarding roaming and/or access restrictions, which may be provided at a connection establishment and/or at the last timing advance (TA) update.

At 1, the source gNB may configure the WTRU measurement procedures. The WTRU may report according to the measurement configuration.

At 2, the source gNB may decide whether to handover the WTRU based on the received measurements.

At 3, the source gNB may issue a handover request message to the target gNB passing a transparent radio resource control (RRC) container with information (e.g., necessary information) to prepare the handover at the target side. The information may include one or more of: the target cell ID, KgNB*, the cell radio network temporary identifier (C-RNTI) of the WTRU in the source gNB, a radio resource management (RRM) configuration (e.g., including WTRU inactive time), a basic AS-configuration including antenna info and DL carrier frequency, the current quality of service (QoS) flow to data radio bearer (DRB) mapping rules applied to the WTRU, the system information block (e.g., SIB1) from source gNB, the WTRU capabilities for different radio access technologies (RATs), protocol data unit (PDU) session-related information, or WTRU reported measurement information (e.g., including beam-related information, if available).

At 4, admission control may be performed by the target gNB.

At 5, the target gNB may (e.g., if the WTRU can be admitted) prepare the handover with L1/L2. The target gNB may send a HANDOVER REQUEST ACKNOWLEDGE to the source gNB, which may include a transparent container to be sent to the WTRU as an RRC message to perform the handover.

At 6, the source gNB may trigger the Uu handover, for example, by sending an RRCReconfiguration message to the WTRU. The message may include the information that may be used to access the target cell, such as one or more of the following: the target cell ID, the new C-RNTI, the target gNB security algorithm identifiers for the selected security algorithms, a set of dedicated random access channel (RACH) resources, the association between RACH resources and synchronization signal block(s) (SSB(s)), the association between RACH resources and WTRU-specific channel state information reference signal (CSI-RS) configuration(s), common RACH resources, system information of the target cell, etc.

At 7, the source gNB may send an SN STATUS TRANSFER message to the target gNB, for example, to convey the uplink packet data convergence protocol (PDCP) SN receiver status and/or the downlink PDCP SN transmitter status of data radio bearers (DRBs) for which PDCP status preservation applies (e.g., for radio link control (RLC) AM).

At 8, the WTRU may synchronize to the target cell. The WTRU may complete the RRC handover procedure, for example, by sending an RRCReconfigurationComplete message to the target gNB.

At 9, the target gNB may send a PATH SWITCH REQUEST message to AMF, for example, to trigger a 5GC to switch the DL data path towards the target gNB and/or to establish an NG-C interface instance towards the target gNB.

At 10, 5GC may switch the downlink (DL) data path towards the target gNB. The UPF may send one or more “end marker” packets on the old path to the source gNB per PDU session/tunnel. The UPF may (e.g., may then) release one or more U-plane/TNL resource(s) towards the source gNB.

At 11, the AMF may confirm the PATH SWITCH REQUEST message with a PATH SWITCH REQUEST ACKNOWLEDGE message.

At 12, the target gNB may (e.g., based on receiving the PATH SWITCH REQUEST ACKNOWLEDGE message from the AMF) send a WTRU CONTEXT RELEASE to inform the source gNB about the success of the handover. The source gNB may (e.g., may then) release radio and C-plane related resources associated with the WTRU context. Ongoing data forwarding (e.g., if it is occurring) may continue.

A conditional handover (HO) and conditional PSCell change (CPC) may be implemented in a wireless network (e.g., NR). A conditional handover (CHO) and/or a conditional PSCell Addition/Change (CPA/CPC, or collectively referred to as CPAC) may reduce the likelihood of radio link failures (RLF) and/or handover failures (HOF).

A handover (e.g., legacy LTE/NR handover) may be triggered by measurement reports. A network may (e.g., additionally) send an HO command to a WTRU without receiving a measurement report. For example, a WTRU may be configured with an A3 event that triggers a measurement report to be sent if the radio signal level/quality (e.g., reference signal received power (RSRP), reference signal received quality (RSRQ), etc.) of a neighbor cell becomes better than the Primary serving cell (PCell) and/or (e.g., also) the Primary Secondary serving Cell (PSCell) (e.g., in the case of Dual Connectivity (DC). The WTRU may monitor the serving and/or neighbor cells. The WTRU may send a measurement report if the conditions are fulfilled. The network (e.g., current serving node/cell) may (e.g., if such a report is received) prepare the HO command (e.g., an RRC reconfiguration message, with a reconfigurationWithSync). The network may send an HO command to the WTRU. The WTRU may (e.g., may immediately) execute the HO command, which may result in the WTRU connecting to the target cell.

A CHO may differ from an HO (e.g., a legacy handover) in one or more aspects. Multiple handover targets may be prepared for a CHO, compared to one (e.g., only one) target for an HO (e.g., legacy HO). A WTRU may not immediately execute a CHO. A WTRU may (e.g., instead) be configured with triggering conditions (e.g., based on the signal level comparison of serving and target cells). The WTRU may execute the handover towards one of the targets if (e.g., only if) the triggering conditions are fulfilled.

A CHO command may be sent if the radio conditions towards the current serving cells are favorable (e.g., still favorable), which may reduce one or more points of failure in HO (e.g., legacy handover). An HO may fail, for example, based on a failure to send a measurement report (e.g., if the link quality to the current serving cell falls below acceptable levels if the measurement reports are triggered in normal handover). An HO may fail, for example, based on a failure to receive a handover command (e.g., if the link quality to the current serving cell falls below acceptable levels after the WTRU has sent the measurement report, but before the WTRU has received the HO command).

The triggering conditions for a CHO may (e.g., may also) be based on the radio quality of the serving cells and/or neighbor cells, such as one or more conditions that may be used in HO (e.g., legacy NR/LTE HO) to trigger measurement reports. For example, a WTRU may be configured with a CHO that has one or more triggering conditions (e.g., A3-like triggering conditions) and/or an associated HO command. The WTRU may monitor the current and serving cells. The WTRU may execute an associated HO command and switch its connection towards a target cell (e.g., instead of sending a measurement report) if the A3 triggering conditions are fulfilled.

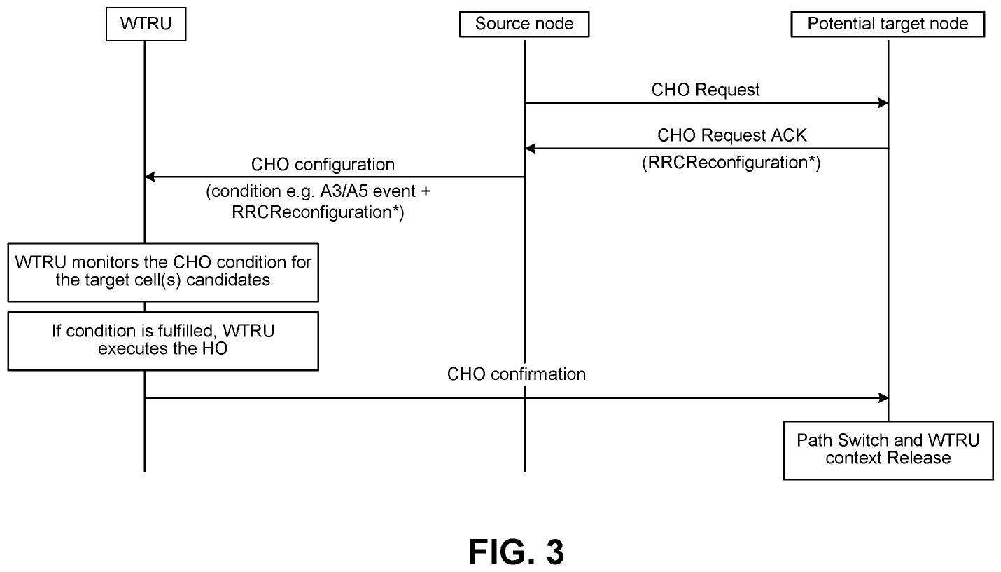

FIG. 3 illustrates an example of a conditional handover (CHO) configuration and execution.

A CHO may help prevent unnecessary re-establishments (e.g., in case of a radio link failure (RLF)). For example, a WTRU may be configured with multiple CHO targets. The WTRU may experience an RLF before the triggering conditions with any of the targets are fulfilled. An HO (e.g., legacy operation) may result in an RRC re-establishment procedure that would have incurred (e.g., considerable) interruption time for the bearers of the WTRU. A WTRU may (e.g., in the case of CHO) detect an RLF. The WTRU may end up in a cell that the WTRU is associated with (e.g., via a CHO association), where the target cell may already be prepared for the WTRU. The WTRU may execute the HO command associated with the target cell directly (e.g., instead of continuing with a full re-establishment procedure).

CPC and CPA may be extensions of a CHO, but in DC scenarios. A WTRU may be configured with triggering conditions for a PSCell change or addition. The WTRU may execute the associated PSCell change and/or PSCell add commands if the triggering condition(s) is (are) fulfilled.

A WTRU may perform one or more measurements. A WTRU (e.g., in RRC_CONNECTED mode) may measure one or multiple beams of a cell. The measurement results (e.g., power values) may be averaged to derive the cell quality. The WTRU (e.g., in doing so) may be configured to consider a subset of the detected beams. Filtering may occur (e.g., take place) at one or more (e.g., two) different levels at the physical layer (e.g., to derive beam quality) and/or at an RRC level (e.g., to derive cell quality) from multiple beams. Cell quality from beam measurements may be derived in the same way for the serving cell(s) and for non-serving cell(s). Measurement reports may include the measurement results of the X best beams if the WTRU is configured to do so by the gNB.

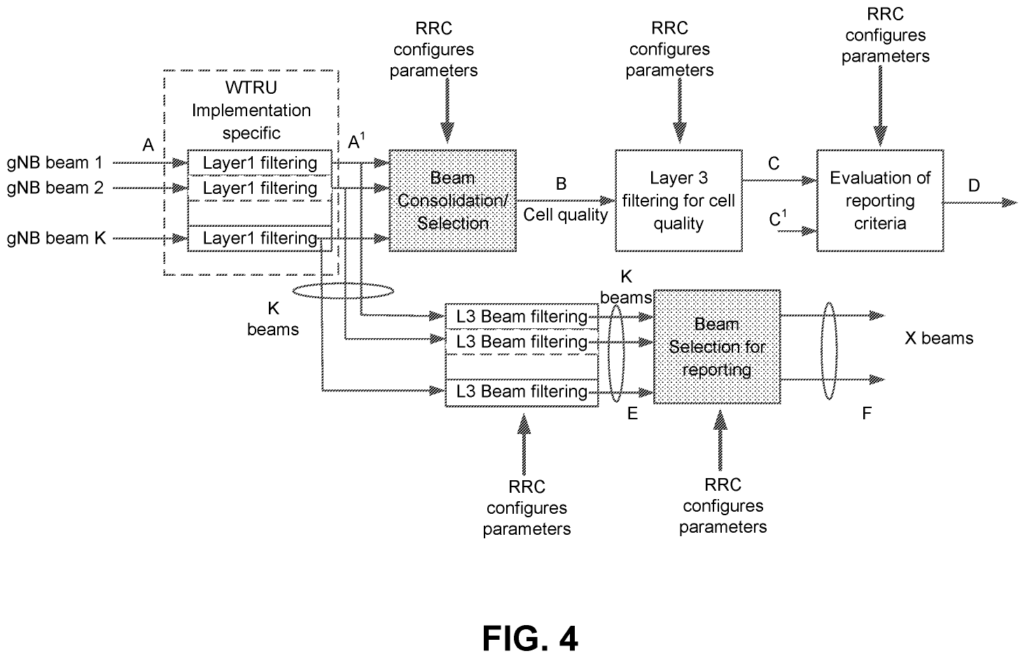

FIG. 4 illustrates an example of a measurement model (e.g., a high-level measurement model). As shown in FIG. 4, K beams may correspond to the measurements on SSB and/or CSI-RS resources configured for L3 mobility by gNB and detected by WTRU at L1.

As shown in FIG. 4 at A, measurements (e.g., beam-specific samples) may be internal to the physical layer.

As shown in FIG. 4 at layer 1 filtering: internal layer 1 filtering of the inputs may be measured at point A. Exact filtering may be implementation dependent.

As shown in FIG. 4 at A¹, measurements (e.g., beam specific measurements) may be reported by layer 1 to layer 3 (e.g., after layer 1 filtering).

As shown in FIG. 4 at beam consolidation/selection, beam specific measurements may be consolidated to derive cell quality. The configuration of the beam consolidation/selection module may be provided by RRC signaling. The reporting period at B may be equal to one measurement period at A¹.

As shown in FIG. 4 at B, a measurement (e.g., cell quality) may be derived from one or more beam-specific measurements reported to layer 3 (e.g., after beam consolidation/selection).

As shown in FIG. 4 at layer 3, filtering for cell quality may be performed. Filtering may be performed on the measurements provided at point B. The configuration of the layer 3 filters may be provided by RRC signaling. The filtering reporting period at C may be equal to one measurement period at B.

As shown in FIG. 4 at C, a measurement may be performed after processing in the layer 3 filter. The reporting rate may be identical to the reporting rate at point B. The measurement may be used as input for one or more evaluations of reporting criteria.

As shown in FIG. 4, evaluation of reporting criteria may check whether (e.g., actual) measurement reporting may be implemented (e.g., may be necessary) at point D. The evaluation may be based on more than one flow of measurements at reference point C (e.g., to compare between different measurements, which is illustrated by input C and C¹). The WTRU may evaluate the reporting criteria (e.g., at least) every time a measurement result (e.g., a new measurement result) is reported at point C, C¹. The configuration may be provided by RRC signaling (e.g., WTRU measurements).

As shown in FIG. 4 at D, measurement report information may be provided in a message sent on the radio interface.

As shown in FIG. 4, L3 beam filtering may perform filtering on the measurements (e.g., beam specific measurements) provided at point A¹. The configuration of the beam filters may be provided by RRC signaling. The filtering reporting period at E may be equal to one measurement period at A¹.

As shown in FIG. 4 at E, a measurement (e.g., beam-specific measurement) may be performed after processing in the beam filter. The reporting rate may be identical to the reporting rate at point A¹. This measurement may be used as an input for selecting the X measurements to be reported.

As shown in FIG. 4, beam selection for beam reporting may select the X measurements from the measurements provided at point E. The configuration of this module may be provided by RRC signaling.

As shown in FIG. 4 at F, beam measurement information may be included in a measurement report (e.g., via a message sent on the radio interface).

Layer 1 filtering may introduce a level of measurement averaging. How and when the WTRU performs the (e.g., required) measurements may be implementation specific to the point that the output at B fulfils the performance requirements. Layer 3 filtering for cell quality and related parameters used may be specified (e.g., without introducing delay in the sample availability between B and C). C¹ may be the input used in the event evaluation. L3 beam filtering and related parameters used may be specified (e.g., without introducing delay in the sample availability between E and F).

Measurement reports may be characterized by one or more of the following. Measurement reports may include the measurement identity of the associated measurement configuration that triggered the reporting. Cell and beam measurement quantities to be included in measurement reports may be configured by the network. The number of non-serving cells to be reported may be limited through configuration by the network. Cells belonging to an exclude-list configured by the network may not be used in event evaluation and reporting. Cells belonging to the allow-list (e.g., only the cells belonging to the allow-list) may be used in event evaluation and reporting, for example, if an allow-list is configured by the network. Beam measurements to be included in measurement reports may be configured by the network (e.g., beam identifier only, measurement result and beam identifier, or no beam reporting).

Intra-frequency neighbor (e.g., neighbor cell) measurements and inter-frequency neighbor (e.g., neighbor cell) measurements may be defined by one or more of the following: an SSB based intra-frequency measurement, an SSB based inter-frequency measurement, a CSI-RS based intra-frequency measurement, or a CSI-RS based inter-frequency measurement. An SSB based intra-frequency measurement may be a measurement where the center frequency of the SSB of the serving cell and the center frequency of the SSB of the neighbor cell are the same (e.g., and the subcarrier spacing of the two SSBs is also the same). An SSB based inter-frequency measurement may be a measurement where the center frequency of the SSB of the serving cell and the center frequency of the SSB of the neighbor cell are different, and/or the subcarrier spacing of the two SSBs is different. In examples (e.g., for SSB based measurements), one measurement object may correspond to one SSB. The WTRU may consider different SSBs as different cells. A CSI-RS based intra-frequency measurement may be a measurement where the subcarrier spacing (SCS) of CSI-RS resources on the neighbor cell configured for measurement is the same as the SCS of CSI-RS resources on the serving cell indicated for measurement. A CSI-RS based intra-frequency measurement may be a measurement where (e.g., for 60 kHz subcarrier spacing) the CP type of CSI-RS resources on the neighbor cell configured for measurement is the same as the CP type of CSI-RS resources on the serving cell indicated for measurement. A CSI-RS based intra-frequency measurement may be a measurement where the center frequency of CSI-RS resources on the neighbor cell configured for measurement is the same as the center frequency of a CSI-RS resource on the serving cell indicated for measurement. A CSI-RS based inter-frequency measurement may be a measurement that is not a CSI-RS based intra-frequency measurement.

A measurement may be non-gap-assisted or gap-assisted. Whether a measurement is non-gap-assisted or gap-assisted may depend on the capability of the WTRU, the active BWP of the WTRU, and/or the current operating frequency. In some examples (e.g., for SSB based inter-frequency measurement), a measurement gap configuration may be provided according to the information, for example, if the measurement gap requirement information is reported by the WTRU. A measurement gap configuration may (e.g., may always) be provided (e.g., otherwise, if measurement gap information is not reported by a WTRU) in one or more of the following cases. A measurement gap configuration may (e.g., may always) be provided if the WTRU supports (e.g., only supports) per-WTRU measurement gaps. A measurement gap configuration may (e.g., may always) be provided if the WTRU supports per-FR measurement gaps and/or if one or more of the serving cells are in the same frequency range of the measurement object. In examples (e.g., for SSB based intra-frequency measurement), a measurement gap configuration may be provided according to the information if the measurement gap requirement information is reported by the WTRU. A measurement gap configuration may (e.g., may always) be provided (e.g., otherwise, if the measurement gap information is not reported by the WTRU) if (e.g., other than the initial BWP) one or more of the WTRU configured BWPs do not include the frequency domain resources of the SSB associated to the initial DL BWP. A WTRU may (e.g., in non-gap-assisted scenarios) carry out such measurements without measurement gaps. A WTRU may (e.g., in gap-assisted scenarios) or may not (e.g., be presumed to) carry out such measurements without measurement gaps.

A WTRU may perform radio link monitoring and/or detection of radio link failure. A WTRU that is in RRC_CONNECTED may (e.g., may need to continuously) monitor the radio link to ensure the link is good/reliable enough for communication, which may be a process referred to as Radio Link Monitoring (RLM). The WTRU may monitor the downlink (DL) quality, for example, based on the reference signal that is being broadcasted from the serving cell.

A WTRU may perform RLM on the Primary Cell (PCell) if the WTRU is operating in single connectivity. A WTRU may perform RLM on the PCell and the primary cell of the secondary cell group (SCG), referred to as a PSCell if the WTRU is operating in dual connectivity (DC).

A WTRU may be configured with RLM reference signals (RLM-RS) to monitor and to determine the radio quality of the PCell (and the PSCell, in case of DC). A network may configure a WTRU to perform the RLM based on a synchronization signal block (SSB) and/or a CSI-RS (e.g., a combination of the two).

A WTRU may be configured with thresholds (e.g., Qout, Qin) to determine whether the radio link being monitored is good/reliable enough. Qout may be the level at which the DL may not be reliably received. Qout may correspond to an out-of-sync block error rate (BLERout) which may be a 10% block error rate of a hypothetical PDCCH transmission. Qin may be the level at which the DL can be more reliably received than at Qout. Qin may correspond to in-sync block error rate (BLERin), which may be a 2% block error rate of a hypothetical PDCCH transmission.

A WTRU may (e.g., may also) be configured with timers and/or counters (e.g. n310, n311, t310) that may be used to determine the reliability of the link being monitored. For example, n310 may be the number of consecutive times that an out of sync indication is received at the RRC from the lower layers (e.g., PHY) before RRC starts considering the link being monitored as experiencing reliability problem. For example, n311 may be the number of consecutive times that an in-sync indication is received at the RRC from the lower layers (e.g., PHY) before RRC considers the link being monitored has become reliable again. For example, t310 may be the duration of the timer that is started if n310 consecutive out-of-sync indications are received from lower layers, and stopped if n311 consecutive in-sync indications are received.

RRC may consider a link as failed and/or declare a radio link failure (RLF) if the T310 timer expires before reception of n311 consecutive in-sync indications from lower layers.

A WTRU may employ a timer (e.g., another timer, such as a t312) to detect an RLF, which may be associated with measurement reporting. A measurement reporting configuration may be associated with t312. A WTRU may check if t310 is already running (e.g., RLM has already identified a problem and is waiting for the recovery) if reporting conditions are fulfilled, a measurement report is to be sent, and/or if the measurement reporting configuration has been associated with t312. A WTRU may start the T312 timer (e.g., with the duration set to the configured t312). The WTRU may declare an RLF if the problem is not resolved before the timer expires. For example, t312 may be used to detect a late HO (e.g., had the measurement reporting been sent earlier than the radio link problem started, the WTRU would probably have been handed over to a target cell in time).

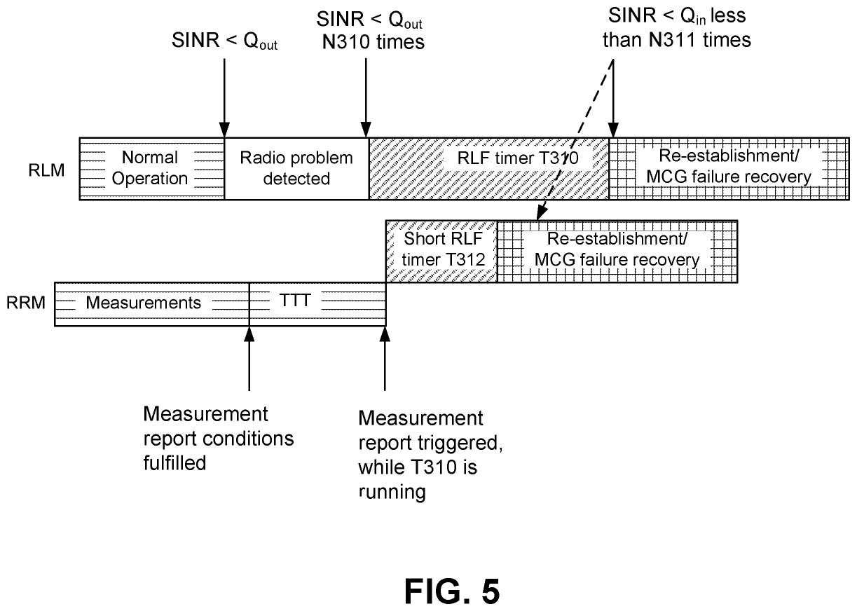

FIG. 5 illustrates an example of RLM and RLF detection mechanisms (e.g., as described herein).

An RLF may be determined/declared (e.g., by an RRC) based on one or more of the following: a random access problem indication from a MAC (e.g., if a WTRU doesn't receive a random-access response (RAR) after sending a random-access preamble to the network a certain number of times); an indication from an RLC that the maximum number of retransmissions has been reached; receiving a back haul (BH) RLF indication on a backhaul adaptation protocol (BAP) entity (e.g., indicating the link between the IAB node and the network has failed) if connected as an integrated access backhaul (IAB)-node; or a (e.g., consistent) uplink listen-before-talk (LBT) failure indication from a MAC if operating in unlicensed mode.

A WTRU may perform RRC re-establishment based on detecting an RLF (e.g., according to one or more causes described herein). A WTRU may perform an RRC re-establishment to recover a radio link. A WTRU may trigger re-establishment based on one or more of the following triggers (e.g., in addition to RLF): a re-configuration with a synchronization (sync) failure with the target cell during an HO; an HO failure from a first RAT (e.g., NR) to another RAT; an integrity check failure for CP data (e.g., data received via SRB1 or SRB2); or an RRC connection reconfiguration failure (e.g., WTRU unable to compile/execute the received RRC reconfiguration file).

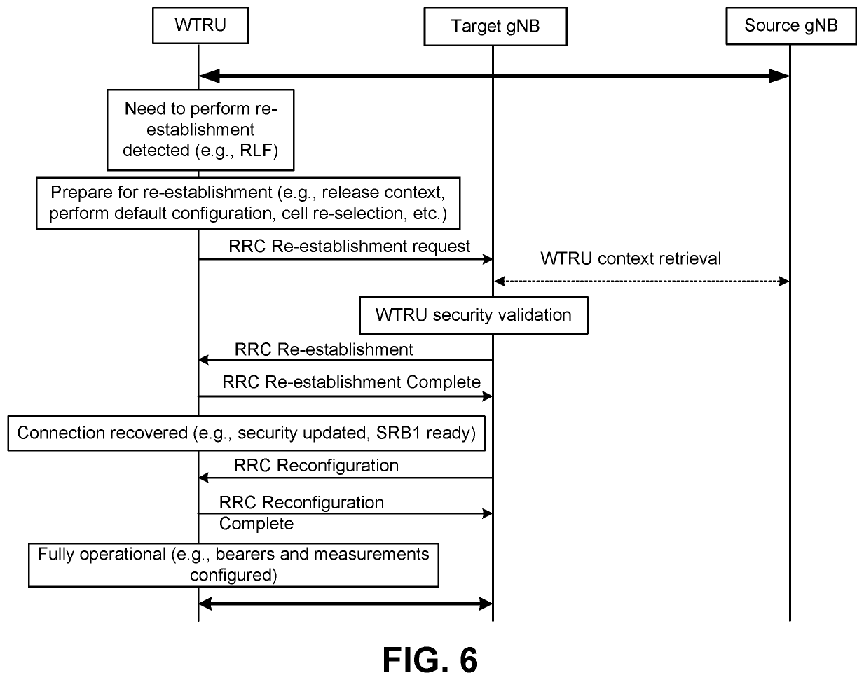

FIG. 6 illustrates a high-level overview of the re-establishment procedure. A WTRU may perform one or more of the following functions during a re-establishment procedure: reset the MAC; release the WTRU configuration/context (e.g., including security configuration); perform cell re-selection (e.g., select the cell with the best radio quality the WTRU may measure at the time); or apply default configurations and/or send an RRC re-establishment request message to the network. A message may include information, such as one or more of following: the identity of the WTRU (e.g., cell radio network temporary identifier (C-RNTI) at the source cell where the re-establishment was triggered, the physical cell identity (PCI) of the source cell, security integrity information that may be derived based on the security configuration that was used at the source cell, or the cause of the re-establishment (e.g., RLF, integrity verification failure, reconfiguration failure, etc.).

A network may use security information included in a re-establishment request to verify whether the request is from a legitimate WTRU. A network may recover the latest WTRU context/configuration using a provided WTRU identity and/or source cell identity. A target gNB may request the WTRU context/configuration information from the source if the WTRU is re-establishing at a target cell different from the source cell and/or the target cell is served by a gNB that is different from the gNB serving the source cell. A network may (e.g., after requesting context/configuration information from a WTRU) send the WTRU an RRC Re-establishment message, which may include information for the WTRU to update the security context. SRB1 may be up and running. The network may send an RRC reconfiguration message to the WTRU to finalize the recovery (e.g., provide new WTRU identity, setup the bearers, configure measurements, etc.). The configuration of the WTRU identity, the bearers, measurements, etc., may be the same configuration used in the source cell before the re-establishment was triggered or may be different, such as if another WTRU at the target is already using the identity, if not the bearers (e.g., all the bearers) may be admitted at the target, if a measurement configuration may have to be modified due to the target's capability/configuration, etc.

A WTRU may perform a re-establishment procedure (e.g., a slightly enhanced re-establishment procedure) if the WTRU is configured with a conditional reconfiguration. A WTRU may not release its context/configuration at the start of the re-establishment procedure. A WTRU may determine if the cell re-selection procedure results in selecting a cell that is a CHO target (e.g., where the WTRU may already have a CHO stored for the target and/or the target is already prepared for the WTRU). The WTRU may execute an associated CHO command (e.g., without continuing with a re-establishment procedure) if the cell re-selection procedure results in selecting a cell that is a CHO target.

A re-establishment procedure may not succeed due to one or more of the following reasons: the WTRU was not able to perform cell re-selection within a given time (e.g., timer T311, which may be started when the WTRU starts the cell re-selection procedure, expires before the WTRU has found a suitable cell to re-establish to); the WTRU was able to find a suitable cell, but the cell became unsuitable before the re-establishment procedure is completed; or the WTRU did not receive a reestablishment message from the network within a given time after sending the re-establishment request (e.g., timer T301, which may be started when the WTRU sends the re-establishment request, expires before reception of the reestablishment command from the network).

A WTRU may (e.g., based on a failed re-establishment procedure) enter RRC_IDLE mode and/or trigger a recovery via connection setup (e.g., from scratch), which may be a longer procedure than re-establishment (e.g., without RAN level context fetching and the CN may be involved in setting up/configuring the bearers). A recovery (e.g., similar recovery) from scratch may be performed (e.g., triggered by the network) if the WTRU context was not retrieved properly based on reception of the re-establishment request.

A WTRU may use an RLM/RLF related timer and constants. A WTRU may be configured with one or more timer values and counters that may be used in the detection and recovery of radio link problems. A WTRU may be provided with a timer and counters configuration in a dedicated (e.g., WTRU specific) and/or broadcasted manner (e.g., cell specific).

An information element (IE) RLF-TimersAndConstants may be used to configure WTRU specific timers and constants. An information element (IE) RLF-TimersAndConstants may be included in a (e.g., main) serving cell configuration (e.g., for the PCell, and if the WTRU is operating in DC, also for the PSCell). Table 1 shows an example of RLF-TimersAndConstants IE syntax. Table 2 shows an example of RLF-TimersAndConstants field descriptions.

TABLE 1
Example of RLF-TimersAndConstants information element syntax

-- ASN1START
-- TAG-RLF-TIMERSANDCONSTANTS-START
RLF-TimersAndConstants ::= SEQUEUNCE {

| | |
|---|---|
| t310 | ENUMERATED {ms0, ms50, ms100, ms200, ms500, ms1000, ms2000, |

ms4000, ms6000},

| | |
|---|---|
| n310 | ENUMERATED {n1, n2, n3, n4, n6, n8, n10, n20}, |
| n311 | ENUMERATED {n1, n2, n3, n4, n5, n6, n8, n10}, |

```
  ...,
  [[
```

| | |
|---|---|
| t311 | ENUMERATED {ms1000, ms3000, ms5000, ms10000, ms15000, ms20000, |

ms30000}
]]
}
-- TAG-RLF-TIMERSANDCONSTANTS-STOP
-- ASN1STOP

TABLE 2
Example of RLF-TimersAndConstants field descriptions

| Field | Description |
|---|---|
| n3xy | Value n1 corresponds to 1, value |
| | n2 corresponds to 2 and so on. |
| t3xy | Value ms0 corresponds to 0 ms, value |
| | ms50 corresponds to 50 ms and so on. |

A WTRU-TimersAndConstants IE may be included in SIB1. The IE may include timers and constants that may be used by the WTRU in RRC_CONNECTED, RRC_INACTIVE, and RRC_IDLE, which may include additional timers used for other purposes. Table 3 shows an example of WTRU-TimersAndConstants information element syntax.

TABLE 3
Example of WTRU-TimersAndConstants information element syntax

-- ASN1START
-- TAG-WTRU-TIMERSANDCONSTANTS-START
WTRU-TimersAndConstants ::= SEQWTRUNCE {

| | |
|---|---|
| t300 | ENUMERATED {ms100, ms200, ms300, ms400, ms600, ms1000, ms1500, |

ms2000},

| | |
|---|---|
| t301 | ENUMERATED {ms100, ms200, ms300, ms400, ms600, ms1000, ms1500, |

ms2000},

| | |
|---|---|
| t310 | ENUMERATED {ms0, ms50, ms100, ms200, ms500, ms1000, ms2000}, |
| n310 | ENUMERATED {n1, n2, n3, n4, n6, n8, n10, n20}, |
| t311 | ENUMERATED {ms1000, ms3000, ms5000, ms10000, ms15000, ms20000, |

ms30000},

| | |
|---|---|
| n311 | ENUMERATED {n1, n2, n3, n4, n5, n6, n8, n10}, |
| t319 | ENUMERATED {ms100, ms200, ms300, ms400, ms600, ms1000, ms1500, |

ms2000},
...
}
-- TAG-WTRU-TIMERSANDCONSTANTS-STOP
-- ASN1STOP

A WTRU may be provided with RLF-timers-AndConstants. The timers/counters configured in RLF-timers-AndConstants may override timers/constants that may be broadcasted in SIB1 in the UE-TimersAndConstants.

A WTRU may engage in beam failure detection and/or beam failure recovery. A WTRU may be configured to maintain one or multiple beam pairs (e.g., in a beamformed NR system). A WTRU may monitor a CSI-RS (e.g., a periodic CSI-RS) on a serving DL beam to assess its quality. The WTRU may compute a corresponding quality metric. The WTRU (e.g., the WTRU's PHY entity) may report a beam failure instance (BFI) to the MAC sub-layer if the beam quality in an RS period for beams (e.g., all beams) in the maintenance set is below a configured threshold.

Lost beam pair(s) may be re-established in a faster manner compared to an RLM/RLF procedure. A WTRU may maintain a BFD procedure in which maintained beams are periodically measured. A beam failure recovery request may be reported to the network based on detecting a beam failure. A BFR may be configured for beam maintenance on a PCell and/or an SCell.

A MAC entity may maintain a beam failure instance counter (BFI_counter) for beam failure detection. A MAC entity may count the number of beam failure instance indications received from the PHY entity. A BFR request may be triggered (e.g., to notify the serving gNB that a beam failure has been detected) if the BFI counter exceeds a maximum number of BFIs. A BFD may be a faster process to detect a link failure compared to RLM (e.g., because L1 measurements may be configured periodically to trigger BFR based on a maximum number of BFIs).

The MAC entity may reset the BFI counter, for example after (e.g., only after) a beamFailureDetectionTimer (BFD timer) has expired, which may help provide hysteresis in the detection function. The WTRU may reset the BFD timer, each time a BFI is indicated. For example, the MAC entity may (e.g., may only) reset the BFI counter after observing no BFI indications from PHY for three consecutive CSI-RS periods (e.g., if the BFD timer is configured to three (3) CSI-RS periods).

A WTRU may (e.g., based on detecting a BFD on the SpCell) start a beamFailureRecoveryTimer (BFR timer) and/or initiate a RA recovery procedure on the SpCell, which may include an indication of a beam failure on PCell in a BFR MAC CE if the RA procedure involves contention-based RA (e.g., as part of msg3). A WTRU may initiate a RA procedure for beam re-establishment. A WTRU may select a PRACH preamble and/or PRACH resource dependent on the measured (e.g., best measured) downlink beam (e.g., CSI-RS or DL SSB). A WTRU may select a beam (e.g., a CSI-RS or an SSB associated with a beam) to re-establish a beam pair during an RA procedure. A WTRU may be configured with a recovery Content Free Random Access (CFRA) preamble (e.g., to indicate the beam) for each CSI-RS. A WTRU may be configured with a candidate beam set (e.g., to evaluate for the recover during the RA procedure), which may be larger than the set of beams monitored during BFD.

A reestablishment RA procedure may be made faster if the gNB configures a set of contention-free PRACH preambles/resources, which may be prioritized for selection by the WTRU if the RA procedure is initiated while the BFR timer is running. A WTRU may select a CFRA preamble if the WTRU finds a CSI-RS measured with a quality above a configured threshold while the BFR timer is running. The WTRU may start evaluating cell SSBs (e.g., which may have wider beamwidths) after the expiration of the BFR timer.

A WTRU may re-establish a beam pair if the WTRU may determine an association between DL beams and UL preambles and/or PRACH occasions. The downlink beam selected by the WTRU may be tested by receiving the random access response (RAR) on it. A BFR may be considered successful based on reception of the RAR for an RA initiated for BFR on a separately configured beam failure recovery search space. An RA initiated by BFR may fail after one or more preamble transmissions (e.g., until RLF and re-establishment is triggered by reaching the maximum number of preamble retransmission attempts (e.g., after PreambleTransMax*RARwindowSize milliseconds)).

A WTRU may report a BFR request for a beam failure detected for the Scell by transmitting a MAC CE indicating the cell on which beam failure was detected. A WTRU may (e.g., after beam failure is detected on an Scell) trigger beam failure recovery by initiating a transmission of a BFR MAC CE for the Scell. A WTRU may (e.g., may also) select a suitable beam for the SCell (e.g., if available), which may be indicated along with the information about the beam failure in the BFR MAC CE. Beam failure recovery for the SCell may be considered complete based on reception of a PDCCH indicating an uplink grant for a transmission (e.g., new transmission) for the HARQ process used for the transmission of the BFR MAC CE.

Beam failure may be detected for a transmission/reception point (TRP) of a serving cell. A WTRU may (e.g., after beam failure is detected for the TRP of the serving cell) trigger beam failure recovery by initiating a transmission of a BFR MAC CE for the TRP. The WTRU may (e.g., may also) select a suitable beam for the TRP (e.g., if available). The WTRU may indicate whether the suitable beam (e.g., new beam) is found or not (e.g., along with the information about the beam failure in the BFR MAC CE for the TRP). Beam failure recovery for the TRP may be considered complete based on reception of a PDCCH indicating an uplink grant for a transmission (e.g., new transmission) for the HARQ process used for the transmission of the BFR MAC CE for the TRP.

A WTRU may engage in beam management. Beams may be characterized. For example, a beam may be associated with a beam identity (beam ID) and/or a beam index. A beam index may be unique to downlink and/or uplink directions. For example, a downlink beam may identify a downlink beam and an associated uplink beam. The association between uplink and downlink beams may be configured and/or implicitly determined based on the outcome of a beam management process and/or the associated UL and DL frequencies.

A WTRU may maintain a beam management process to determine which beam IDs to maintain, activate, deactivate, and/or consider for as a candidate for activation (e.g., among other actions). A beam management process may keep track of a list of maintained beams and/or a list of candidate beams. A beam management process may carry actions related to BFD and BFR. A beam management process may be used to change beam states. Beams (e.g., each beam) may have one or more of the following states: active and/or maintained; de-active; candidate; initial state; or adjusted state.

A beam may have an active and/or a maintained state. A WTRU may measure associated CSI-RS or SSBs (e.g., part of BFD). A WTRU may monitor associated PDCCH resources or search spaces. A WTRU may activate a beam based on reception (e.g., after reception) of activation signaling (e.g., by semi-static configuration, such as a default active beam) and/or based on measuring (e.g., after measuring) a channel state quantity for an associated measurement resource below a configured threshold.

A beam may have a de-active state. A WTRU may not measure associated CSI-RS or SSBs (e.g., part of BFD). The WTRU may de-activate a beam after reception of de-activation signaling, after declaring a beam failure, and/or after measuring a channel state quantity for an associated measurement resource below a configured threshold.

A beam may have a candidate state. A beam in a candidate state may (e.g., may also) be a de-active beam. A beam ID may be a candidate if configured by higher layer signaling and/or determined by the WTRU (e.g., based on channel condition measurements on associated CSI-RS/SSBs). A WTRU may measure associated CSI-RS or SSBs (e.g., as part of BFR for a candidate beam, such as for beam reselection).

A beam may have an initial state. A beam (e.g., in an initial state) may be transmitted/received with default parameters (e.g., beamwidth, etc.).

A beam may have an adjusted state. A beam (e.g., in an adjusted state) may be transmitted/received with modified parameters.

A beam may be characterized by at least one of the following: one or more beam parameters; beam width and/or a beam directivity index; a beam type; a beam reference signal; or one or more beam transmission configuration indicator (TCI) states.

A beam may be characterized by one or more beam parameters. Beam parameters may include one or more of the following: applied (e.g., spatial) filter, codebook(s), precoding table(s) and/or weight(s), RF phase shift(s), channel state information (CSI), whether the beam is a downlink beam, an uplink beam or a bidirectional beam, whether the channel may be considered reciprocal (e.g., in case of TDD) or not (e.g., in case of FDD), etc. For example, a WTRU may be configured with a plurality of beams. Beams (e.g., each beam) may be associated with a different set of parameter(s). Parmeter(s) (e.g., each parameter) may have an assigned value (or value range). For example, a WTRU may be configured with a plurality of beams, where each beam may be associated with a spatial filter.

A beam may be characterized by a beam width and/or a beam directivity index. For example, a WTRU may be configured to associate a beam with a width. A beam width may correspond to a set of beam parameter(s). For example, a beam width may correspond to one or more weighting patterns. For example, a width may correspond to a spatial filter.

A beam may be characterized by a beam type. For example, a beam may be omnidirectional or directional, which may be considered a special case of a beam width characterization.

A beam may be characterized by a beam reference signal. For example, a beam may be associated with a synchronization signal block (SSB) or a channel state information reference signal (CSI-RS) (e.g., for measuring the quality of the DL beam, for beam failure detection, and/or for identifying a beam).

A beam may be associated with (e.g., characterized by) one or more transmission configuration indicator (TCI) states. A TCI may be used by the network to indicate the (de)-activation status of a beam for a physical downlink control channel (PDCCH) and/or a physical downlink shared channel (PDSCH) transmission. A beam may (e.g., may also) be associated with an uplink TCI state.

For example, a WTRU implementation may meet requirements for one or more beam characteristics (e.g., as described herein), such as a testing aspect of the WTRU implementation. A testing aspect may include the expected pattern of radiation, the spectral leakage of the radiation pattern, and/or the likes. Different WTRU implementations may conform to specific sensitivity levels, spectral emission patterns, and/or may achieve conformity (e.g., such that different beams meeting specific requirements may be supported).

For example, a WTRU implementation may support one or more beam characteristics (e.g., as described herein), such that different beams with different interference characteristics and/or beam width may be available. The WTRU may report beam availability to the network as part of the WTRU capability exchange.

A WTRU may be configured with a plurality of beams (e.g., as described herein). For example, a WTRU may be configured with beam ID=0 for an omnidirectional beam, and with beam ID!=0 for directional beams. The WTRU may be (e.g., may be further) configured with one or more directional beams. For example, the WTRU may be configured with beam ID=1 associated with a first beam width x=1, with beam ID=2 associated with a second beam width x=2, and so on (e.g., up to a maximum number of beams). The maximum number of directional beams may be a WTRU capability.

A WTRU may be configured with a reference signal (e.g., SSB, CSI-RS) configuration for a given beam. A WTRU may be configured such that a reference signal configuration may be assigned with a plurality of beam widths. A beam reference signal configuration may be associated with a plurality of beam width indices. Indexes (e.g., each index) may correspond to a (e.g., at most one) beam width. A beam may be defined (e.g., in such a case) based on its reference signal configuration, where control thereof may be associated with changes in the beam width index. For example (e.g., in another realization), the beam width index may correspond to a beam ID.

A WTRU may receive control signaling (e.g., on a first beam carrying the control channels, such as a PDCCH) that includes an index to a beam configuration for the reception of data (e.g., for a DL beam on a data channel such as a PDSCH), for the transmission of data (e.g., for a bi-directional beam on an uplink channel, such as a physical uplink shared channel (PUSCH)), and/or for transmission of control information (e.g., for a bi-directional beam on an uplink control channel, such as a physical uplink control channel (PUCCH)) using the indicated beam configuration.

A WTRU may receive control signaling that indicates the (de)-activation of a beam configuration, beam index, and/or associated beamwidth(s). A (de)-activation indication may be applicable to a direction (e.g., downlink), a channel (e.g., PDSCH, PDCCH, PUSCH, PUCCH, physical random access channel (PRACH)), and/or for a subset of transmission types (e.g., paging, UCI type, data type). Control signaling may be dynamic (e.g., received on a MAC CE or DCI) or semi-static (e.g., received by an RRC (re)-configuration).

The term reference signal may refer to any signal, preamble, or system signature that may be received and/or transmitted by the WTRU (e.g., for one or more of the purposes described herein). Different reference signals may be defined for beam management in the DL and/or UL. For example, downlink beam management may use CSI-RS, DMRS, a synchronization signal, or similar. For example, uplink beam management may use SRS, DMRS, RACH, or similar.

A WTRU may be configured with one or more TCI states. A WTRU may use a TCI state, for example, for the purpose of determining antenna port quasi co-location (QCL) information associated with PDSCH reception. A WTRU may be configured with up to M TCI states. A TCI state may include one or more sets of RSs. An RS may be associated with a QCL relationship with a DMRS port of a PDSCH. A QCL relationship may be of a specific type. For example, a type of QCL relationship may correspond to one or more channel characteristics (e.g., Doppler shift, a Doppler spread, a delay spread, etc.) and/or a spatial RX relation. A WTRU may be configured to decode a PDSCH based on TCI state information in the received DCI.

A mechanism and procedures of L1/L2 based inter-cell mobility for mobility latency reduction may include one or more of the following: configuration and/or maintenance for multiple candidate cells to allow fast application of configurations for candidate cells (e.g., RAN2, RAN3); a dynamic switch mechanism among candidate serving cells (e.g., including SpCell and SCell) for one or more applicable scenarios based on L1/L2 signaling (e.g., RAN2, RAN1); L1 operation for inter-cell beam management, which may include L1 measurement and reporting and/or beam indication (e.g., RAN1, RAN2, for example, with early RAN2 involvement); timing advance management (e.g., RAN1, RAN2); or CU-DU interface signaling to support L1/L2 mobility, if needed (e.g., RAN3). A procedure of L1/L2 based inter-cell mobility may be applicable to one or more the following scenarios: standalone (e.g., CA and NR-DC case with serving cell change within one CG); intra-DU case and/or intra-CU inter-DU case (e.g., applicable for standalone and/or CA); intra-frequency and/or inter-frequency; FR1 and/or FR2; or source and target cells that may be synchronized or non-synchronized.

L1/L2 based mobility and inter-cell beam management may address intra-DU and intra-frequency scenarios. A serving cell may remain unchanged (e.g., there is no possibility to change the serving cell using L1/2 based mobility). CA may be used (e.g., in FR2 deployments), for example, to exploit the available bandwidth (e.g., to aggregate multiple CCs in one band). The CCs may be transmitted with the same analog beam pair (e.g., gNB beam and WTRU beam). A WTRU may be configured with TCI states (e.g., 64 TCI states) for reception of PDCCH and PDSCH. TCI states (e.g., each TCI state) may include an RS and/or an SSB that the WTRU refers to for setting its beam. An SSB may be associated with a non-serving PCI. MAC signaling (e.g., a TCI state indication for WTRU-specific PDCCH MAC CE) may activate the TCI state for a control resource set (CORESET)/PDCCH. Reception of PDCCH from a non-serving cell may be supported by a MAC CE indicating a TCI state associated with a non-serving PCI. MAC signaling (e.g., TCI states activation/deactivation for a WTRU-specific PDSCH) may activate a subset of (e.g., up to) eight TCI states for PDSCH reception. A DCI may indicate which of the eight TCI states to activate. A TCU state, which may be a unified TCI state, may be supported with a different updating mechanism (e.g., DCI-based) without multi-TRP. A unified TCI state may be supported with multi-TRP.

L1/2 inter-cell mobility may improve handover latency. An L3 handover or conditional handover may involve the WTRU sending (e.g., first sending) a measurement report (e.g., using RRC signaling). A network may (e.g., in response) provide a measurement configuration (e.g., further measurement configuration) and/or a conditional handover configuration. A network may (e.g., with a conventional handover) provide a configuration for a target cell after the WTRU reports (e.g., using RRC signaling) that the cell meets a configured radio quality criteria. A conditional handover may reduce the handover failure rate due to the delay in sending a measurement report and then receiving an RRC reconfiguration. A network may provide (e.g., for a CHO), in advance, a target cell configuration and/or measurement criteria that may determine if the WTRU should trigger the CHO configuration. An L3 and/or a CHO may have some amount of delay due to the sending of measurement reports and receiving of target configurations (e.g., particularly in case of a non-conditional handover).

L1/2 based inter-cell mobility may allow application (e.g., fast application) of configurations for candidate cells including dynamically switching between SCells and/or switching of the PCell (e.g., switch the roles between SCell and PCell) without performing RRC signaling. Inter-CU switching may involve relocation of the PDCP anchor. An RRC based approach may support an inter-CU handover. L1/2 may support/allow CA operation to be enabled instantaneously based on a serving cell change.

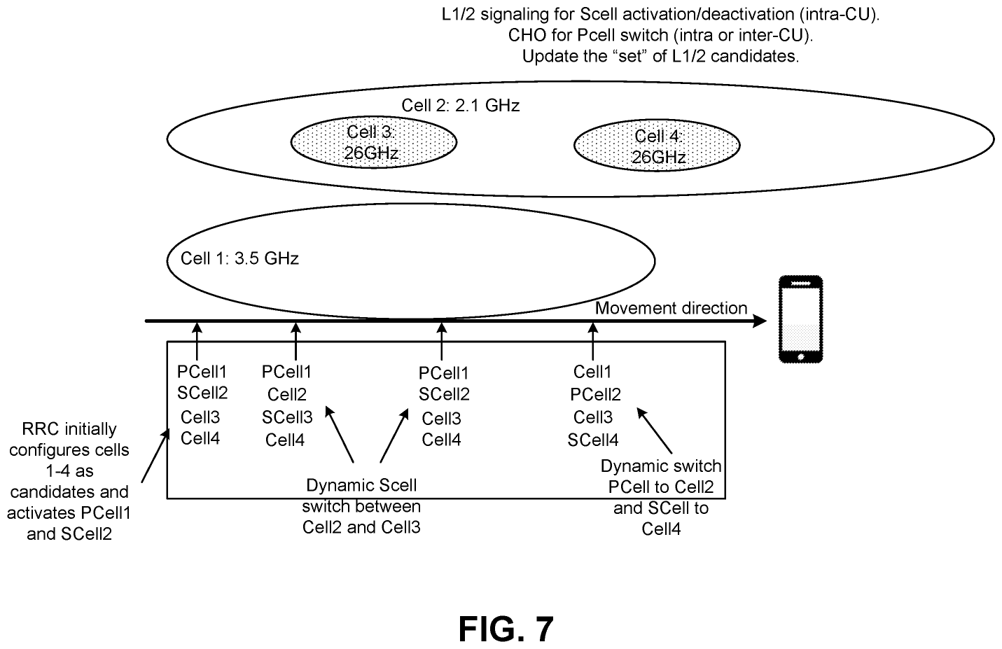

FIG. 7 illustrates an example of L1/2 inter-cell mobility using carrier aggregation (CA). FIG. 7 shows an example of L1/2 inter-cell mobility operation, where the candidate cell group may be configured by RRC and a dynamic switch of PCell and SCell may be achieved using L1/2 signaling.

Fast switching may be performed between cells, such as SpCells (e.g., PCell and/or PSCell). There may be pre-configuration of the candidate cells at the RRC layer so that the configuration of the target SpCell(s) can be applied based on (e.g., upon) receiving an indication from L1/2 (e.g., in support of fast switching). Candidate cells may have at least one of an SpCell configuration and an SCell configuration, which may be applied (e.g., dynamically applied) based on an indication at lower layers (e.g., at MAC CE or DCI).

Mobility decisions (e.g., SCell addition/removal, SCell change, SpCell change, HO/CHO configuration) may be made based on measurement reporting (e.g., event) configurations at an RRC level. For example, a gNB may configure a CHO if a WTRU triggers a measurement report based on an event (e.g., event A2, where serving becomes worse than threshold). An SpCell change (e.g., HO) may be initiated based on WTRU sending a measurement report that is triggered due to the fulfilment of an event (e.g., event A3, where a neighbor becomes offset better than SpCell, or event A5, where an SpCell becomes worse than threshold1 and neighbor becomes better than threshold2). An SCell addition may be performed if the WTRU sends a measurement report that is triggered due to the fulfilment of an event (e.g., event A4, where a neighbor becomes better than threshold). An SCell change may be performed based on the fulfilment of an event (e.g., event A6, where a neighbor becomes offset better than SCell), etc.

In examples (e.g., legacy NR operations), L1 measurements may be reported to the DU (e.g., CQI reports), which may be suitable for scheduling purposes if a CU-DU split architecture can be employed. Cell changes or reconfigurations may involve a significant amount of processing, which may not be performed infrequently based on the L1 signaling and/or if (e.g., only if) a stable measurement result as a basis for a reconfiguration decision can be determined. L3 measurements (e.g., measurements that are filtered at L3 to filter out short term fluctuations) may be used for making mobility decisions. L3 measurements may be sent to the CU (e.g., where the RRC is terminated). The CU's RRC may (e.g., based on the L3 measurements) send reconfiguration messages that instruct the WTRU to perform mobility (e.g., an HO command for immediate mobility, a CHO for mobility if/when conditions are fulfilled, etc.).

A BFD and subsequent BFR may enable a WTRU to recover a connection faster than an RLF procedure. However, a WTRU may declare an RLF (e.g., and may perform re-establishment) if there are no alternate beams available. Re-establishment may be undesirable because it can create considerable service interruption for the WTRU and/or cause signaling overhead at the network (e.g., for air interface for full reconfiguration and/or for X2 interactions between source and target, if the WTRU context is to be fetched in order to avoid involving the CN).

The likelihood of BFR success may be increased in the context of L1/L2 mobility, where latency may be of utmost importance. Candidate cells/beams may be leveraged for L1/L2 mobility.

BFD and BFR examples described for the BFR MAC CE may be applicable for a MAC CE (e.g., a new MAC CE) and/or a mobility-triggered MAC CE, which may be triggered by BFD on the source cell, an RLF, an event that causes RRC re-establishment, and/or a determination of change in the serving cell's NES state.

A WTRU may apply one or more of the mobility, reporting, and/or recovery examples by detection of BFD based on determining that the serving cell has changed its NES state (e.g., entered a sleep state or turned off) and/or after reception of signaling indicting an NES state change or L1/2 mobility.

The term measured “channel conditions” may include one or more conditions relating to the state of the radio/channel, which may be determined by the WTRU from or based on one or more of the following: a WTRU measurement (e.g., L1/SINR/RSRP, CQI/MCS, channel occupancy, RSSI, power headroom, exposure headroom), L3/mobility-based measurements (e.g., RSRP, RSRQ, s-measure), an RLM state, a BFD state, a measurement relaxation state, or channel availability in unlicensed spectrum (e.g., whether the channel is occupied, for example, based on determination of an LBT procedure or whether the channel is deemed to have experienced a consistent LBT failure). A channel measurement may be associated with one or more beams. A channel measurement may be evaluated using a quality/SINR type of measurement value (e.g., BLER level evaluated against a Qin value) and/or using a received power level value (e.g., RSRP).

The term “equivalent cells” or “alternate cells” may be used to describe a group of cells (e.g., cells belonging to the same DU, cell belonging to the same CU, cells configured for L1/L2 mobility, cells in the same cell group, etc.) that may be used for recovery from a BFD on a serving cell. A WTRU may be configured (e.g., explicitly) with a list of cell identities (e.g., PCI, CGI) that indicate which cells belong to the same DU and/or CU (e.g., or which cells belong to the same CU or DU as a serving cell). A WTRU may be able to (e.g., implicitly) determine which cells belong to the same DU and/or CU by reading/analyzing the system information of the concerned cells.

A WTRU may be configured with one or more BFR resources (e.g., additional BFR resources) associated with one or more non-serving cells. In examples, a WTRU may be configured with at least one set of resources corresponding to candidate beams of at least one non-serving cell (e.g., or candidate cell, or neighboring cell) for the purpose of beam failure recovery. A WTRU may be configured with the at least one set of resources corresponding to candidate beams of at least one non-serving cell (e.g., in addition to at least one set of resources corresponding to candidate beams of the serving cell). Sets of resources (e.g., each set of resources) corresponding to a non-serving cell may be included within a BFR configuration, which may be specific to the non-serving cell. Parameters and/or resources may be included as part of a common beam failure recovery configuration. Resources (e.g., each resource) may be identified by a periodic CSI-RS index and/or by a SS block index with an associated physical cell identity (PCI). The resources and/or configurations may be activated/deactivated by MAC signaling.

A measurement quantity may be configured and/or determined for recovery measurement. The measurement quantity used for the selection of resource during RACH procedure and/or for reporting in a BFR MAC CE may be an SS-RSRP (e.g., for SSB) and/or CSI-RSRP (e.g., for CSI-RS). The measurement quantity may be SS-SINR and CSI-SINR (e.g., for SSB) and/or SS-RSRQ and CSI-RSRQ (e.g., for CSI-RS). The applicable measurement quantity may be configured as part of the beam failure recovery configuration.

One or more beams may be included from candidate cells in a BFR MAC CE.

A WTRU may be configured with absolute and/or relative thresholds to compare beams of candidate cells and beams of the cell where BFD is detected.

A candidate cell's beams may include beams bigger than a threshold. A candidate cell's beams may include beams that are a threshold better than the beams of the PCell (e.g., beams that are better than the best beam on the PCell by a threshold and/or beams that are better than the average/mean beam signal on the PCell by an amount). A candidate cell's beams may include beams measured with measured channel conditions above a configured quality threshold. A candidate cell's beams may include beams for a candidate cell with a channel measurement above a configured threshold (e.g., an L3 measurement, such as SS-RSRP).

The number of beams of a candidate cell may include the beams (e.g., all the beams) that fulfill the conditions (e.g., as described herein); the top n beams that fulfill the conditions (e.g., as described herein); and/or the top n beams of the candidate cell with beams that fulfill the conditions (e.g., as described herein).

The number of candidate cells may include the candidate cells (e.g., all the candidate cells) that have beams that fulfill the conditions (e.g., as described herein); the candidate cells (e.g., all the candidate cells) that have at least a certain number of beams that fulfill the conditions (e.g., as described herein); and/or the top n candidate cells (e.g., a first cell that has a very good beam and/or a second cell that has several beams that may be marginally worse than the strongest beam of the first cell).

Supplementary measurements may be caused by a BFD. One or more determinations may be made about a recovery procedure, whether to perform mobility, and/or where to send a MAC CE.

In examples herein, “neighboring cell” and “candidate cell” may be used interchangeably. In examples, a neighboring cell be a candidate cell or may include a candidate cell.

A WTRU may (e.g., based on the detection of a BFD, RLF, and/or an NES state change on a serving cell) start measurements (e.g., additional measurements) on the source and/or a number of neighboring cells (e.g., a list of configured candidate cells and/or a list of equivalent/alternate cells associated with the serving cell). The WTRU may (e.g., may also) start such measurements prior to BFD (e.g., for (e.g., only for) BFD on the SpCell), for example, if the BFD counter on the serving cell is above a configured count threshold.

A WTRU may start (e.g., on the serving cell) channel measurements associated with a list (e.g., an expanded list) of beam candidates (e.g., a configured beam candidate list bigger than the BFD set or the list of beam candidates associated with BFR).

A WTRU may (e.g., on a neighboring cell, such as a non-serving cell, a candidate cell, and/or an equivalent cell associated with the serving cell) start measuring a list of configured beams (e.g., a configured set of beams on the neighboring cell (e.g., the BFD set for the neighboring cell)), and/or an L3/mobility measurement associated with the neighboring cell.

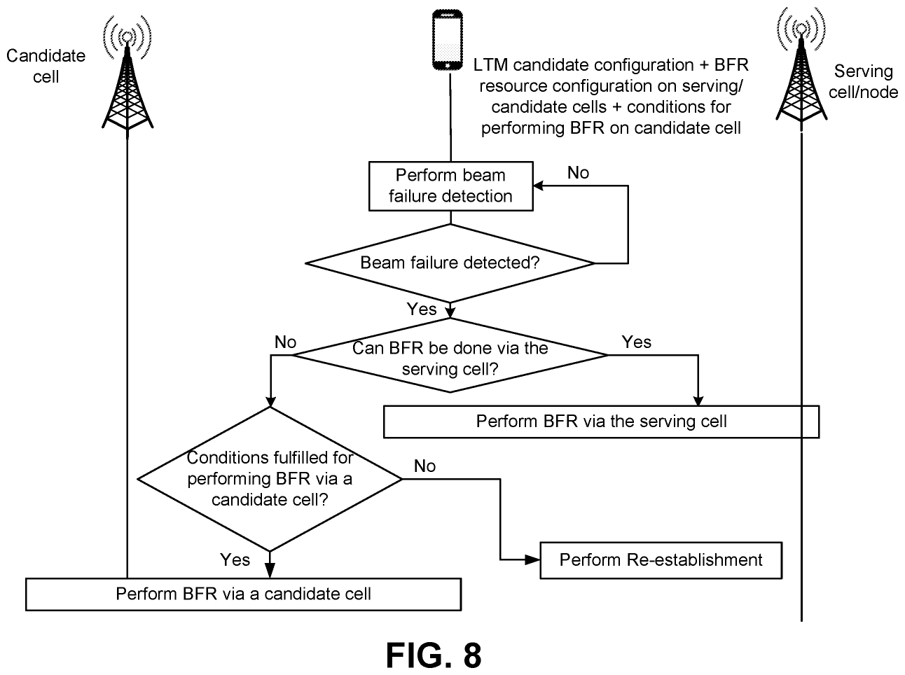

FIG. 8 illustrates example feature(s) associated with performing BFR. A WTRU may be configured with (e.g., receive configuration information that indicates) a candidate configuration (e.g., an LTM candidate configuration). The candidate configuration may indicate a candidate cell (e.g., an LTM candidate cell) or may indicate a set of beams per candidate cell (e.g., per LTM candidate cell, per CHO candidate cell, per equivalent cell) (e.g., as shown in FIG. 8). The WTRU may perform channel measurements on the configured candidate cell (e.g., on the beams of the candidate cell) based on a BFD on the serving cell (e.g., only the SpCell) or prior to BFD. The WTRU may perform a light BFD procedure on the candidate cells, which may be conditioned on at least one of the following: receiving a BFI from one or more cells in the MAC entity (e.g., limited to the SpCell), having the BFD counter on the serving cell (e.g., SpCell) higher than a threshold, not measuring a candidate beam from the BFD set above the Qin threshold, not measuring a candidate beam from the BFR set of the SpCell above the Qin threshold, or not measuring an SSB from the SpCell above a threshold.

A WTRU may perform one or more of the supplementary measurements caused by BFD (e.g., as described herein). The WTRU may perform one or more of the supplementary measurements (e.g., before BFD is detected) if at least one of the following conditions is met/satisfied: the BFI count is greater than a configured threshold that is less than max BFI; a BFD is detected on an SCell (e.g., part of the same MAC entity); a BFD is detected on an associated MAC entity (e.g., BFD on the PSCell of a secondary cell group); an MCG failure, SCG failure, or a consistent UL LBT failure is detected; the BFR time has expired; or the BFR timer has expired and the WTRU hasn't received an RAR, an msg4, a BFR response from the gNB, and/or a response from the network (e.g., feedback or a follow up msg) following the transmission of the (e.g., enhanced) BFR MAC CE.

A WTRU may perform a recovery and/or a reporting procedure following BFD on a serving cell (e.g., the SpCell), such as after performing supplementary measurements caused by a BFD. The reporting procedure may involve at least one of sending a BFR MAC CE, reporting an MCG failure, or reporting an SCG failure. The recovery procedure (e.g., BFR procedure) may involve at least one of: a BFR on the cell on which BFD was detected (e.g., the serving cell or the SpCell) (e.g., as shown in FIG. 8), initiating a BFR-RA procedure, initiating supplementary measurements caused by a BFD on the serving cell(s) and/or candidate cell(s) (e.g., as described herein), performing a mobility/handover procedure (e.g., to measured candidate cell(s), including handover, CHO, or L1/L2 handover), or recovery actions following an MCG or an SCG failure.

A WTRU may attempt (e.g., first attempt) recovery on the cell on which BFD was detected (e.g., SpCell), by initiating an RA-BFR on the SpCell (e.g., as shown in FIG. 8). If the BFR cannot be performed via the serving cell, the WTRU may (e.g., may then) attempt recovery on a different cell (e.g., on a candidate cell, as shown in FIG. 8) following the expiration of the BFR timer (e.g., or another timer that is defined for the case of step wise recovery). A WTRU may (e.g., following the expiration of the BFR timer) perform at least one of the following actions: perform recovery on another serving cell; perform recovery on candidate cell(s); start measurements on candidate cell(s) (e.g., as described herein per supplementary measurements caused by BFD); abort or stop an ongoing RA procedure (e.g., on the SpCell); start another RA procedure on the candidate cell(s); or start evaluating CHO candidates or execute a CHO command.

A WTRU may determine which cell(s) to include in a recovery and/or reporting procedure depending on supplementary measurements performed after BFD. A WTRU may initiate a recovery and/or reporting procedure (e.g., including initiating a RACH procedure on the SpCell and/or sending a MAC CE via the SpCell) if one or more suitable beams are still available on the SpCell (e.g., with a channel measurement above a configured threshold (e.g., Q_{in, BFD} or Q_{in, RLM} or another threshold)). A WTRU may trigger a BFR-RA procedure on the PCell based on detection of a BFD if at least one beam candidate in the cell was measured with a channel measurement above a threshold.

A WTRU may include a candidate cell index and/or an associated beam or cell channel measurement part of a BFR MAC CE (e.g., an enhanced BFR MAC CE) (e.g., even if the WTRU performs the recovery on the SpCell (e.g., the cell on which BFD was detected)). The WTRU may (e.g., further) perform a reporting procedure by including the BFR MAC CE (e.g., the enhanced BFR MAC CE) (e.g., even if the recovery is performed on the SpCell or a different cell from that indicated in the BFR MAC CE). The WTRU may perform the reporting procedure if at least one of the following conditions is met/satisfied: the SpCell has at least one beam with a channel measurement above the threshold (e.g., Qin); a candidate cell (e.g., a preconfigured cell for L1/2 or a CHO candidate) has a beam with a channel measurement above a threshold (e.g., a second threshold); or a candidate cell has a beam with a channel measurement with a margin above the best measured beam on the SpCell, where the margin threshold is configured.

A WTRU may receive an indication of condition(s) to perform BFR via a candidate cell (e.g., LTM candidate cell) (e.g., as shown in FIG. 8). Based on detecting the serving cell beam failure, the WTRU may perform recovery and/or reporting on the candidate cell if the WTRU determines that no suitable beams are still available on the serving cell (e.g., the SpCell cell). Based on detecting the serving cell beam failure, the WTRU may condition (e.g., may further condition) performing recovery and/or reporting on the candidate cell if the WTRU determines that at least one of the following conditions is fulfilled (e.g., as shown in FIG. 8): at least one beam with measured channel conditions is above a threshold (e.g., Qin); an L3 channel measurement is above a threshold and/or higher than that of the serving cell; there no not measurements of a beam (e.g., including CSI-RS and SSBs) on the serving cell (e.g., SpCell) with a channel measurement above a threshold; at least a minimum number of beams on the candidate cell (e.g., LTM candidate cell) measured with a quality above a threshold; one or more candidate cells have beams with better radio conditions (e.g., channel measurements) than the best beam of the serving cell (e.g., the SpCell) (e.g., based on a configured absolute/relative threshold comparison of the candidate cell and the SpCell, such as if the WTRU compares the maximum or average channel measurements associated with the candidate cell and the SpCell); a consistent UL LBT failure is detected; or the BFR timer on the SpCell has expired. If the WTRU determines that at least one of the conditions above is not fulfilled, the WTRU may perform re-establishment (e.g., as shown in FIG. 8).

The WTRU may (e.g., may only) consider candidate cells for recovery if they are: preconfigured for L1/2 mobility, preconfigured with measurement resources (e.g., BFD resources), equivalent cells to the serving cell, or cells in the same cell group or DU.

The WTRU may initiate a RACH (e.g., a BFR RA) on one of the candidate cells that have beam(s) indicated in the BFR MAC CE. Multiple candidate cells may meet the conditions for recovery. A WTRU may prioritize or select a candidate cell for recovery as the cell with the highest L3 measurement, largest number of beams measured above a threshold, and/or the cell being an equivalent cell to the serving cell.

A WTRU may receive a BFR resource configuration indicating a resource(s) (e.g., RACH resources) associated with the candidate cell (e.g., the LTM candidate cell) (e.g., as shown in FIG. 8). The WTRU may (e.g., for a recovery RA procedure initiated on (e.g., start towards) the candidate cell) select the RACH resources associated with the BFR resource configuration (e.g., CFRA-BFR resources, if configured and/or if applicable at the candidate cell) associated with the candidate cell (e.g., the LTM candidate cell). The WTRU may (e.g., may further) apply prioritized RA parameters (e.g., including backoff time and power ramping step size, associated with an RA-BFR or handover). A WTRU may reuse one or more of the PRACH configurations of the source cell if the candidate cell is an equivalent cell. A WTRU may use one or more resources (e.g., a subset of PRACH configured for reporting BFD on a different cell) on the candidate cell to perform the BFR. For example, BeamFailureRecoveryConfig may include resources from a candidate cell, may be pre-configured per candidate cell, and/or may be reused for one or more candidate cells. A WTRU may be configured with a BFR search space (e.g., per candidate cell), which the WTRU may monitor for the reception of the BFR response form the gNB (e.g., the target cell). A WTRU may be configured with RACH resources for a non-serving cell BFR that may be separated from the resources configured for serving cell BFR recovery, which may be configured by a current (e.g., serving) cell and/or the WTRU may acquire system information of the target (e.g., candidate) cell and receive a configuration (e.g., directly) from the cell. This may provide the gNB with a method of distinguishing an RA attempt for BFR from a WTRU currently connected to another candidate cell (e.g., the serving cell on which beam failure was detected) from an RA attempt from a WTRU currently connected to the cell (e.g., the cell on which a WTRU may attempt a non-serving cell BFR on).

A WTRU may consider the recovery and/or reporting procedure successful after at least one of the following: (e.g., successful) completion of an RA performed on the target cell (e.g., candidate cell); (e.g., successful) reception of an RRC reconfiguration on the target cell (e.g., candidate cell); measuring one or more beams on the target cell (e.g., candidate cell) with a channel measurement above a threshold; receiving a PDCCH addressed to the WTRU's C-RNTI (e.g., received on the configured BRF search space); or receiving a response from the gNB, for example, following the transmission of a (e.g., an enhanced) BFR MAC CE (e.g., msg4 and/or HARQ feedback for the HARQ process on which the MAC CE was transmitted).

A WTRU may (e.g., if the recovery procedure is successful) apply a serving cell change (e.g., SpCell change). For example, the WTRU may send a BFR MAC CE to a non-serving cell. The BFR MAC CE may be sent with information of the best beam of the candidate cell (e.g., the LTM candidate cell). The non-serving cell may issue a L1/2 handover trigger (e.g., in a MAC CE), and the WTRU may perform an RRC reconfiguration from the previous cell to the new cell based on the handover trigger from the target) cell (e.g., BFR cell) and/or the stored (e.g., pre-configured) RRC configuration for the L1/2 mobility candidate cell. The gNB may issue the L1/2 handover trigger (e.g., immediately, using RAR, Msg4, or a DCI including the explicit HO trigger) if the gNB is able (e.g., using separate RA resources) to distinguish a BFR from a WTRU currently connected to another serving cell.

The following features are described herein and are shown in FIG. 8. As shown in FIG. 8, the WTRU may receive configuration information. The configuration information may include an LTM candidate configuration and a BFR resource configuration. The WTRU may (e.g., may also) receive condition(s) for performing BFR on a candidate cell.

As shown in FIG. 8, the WTRU may perform beam failure detection (e.g., on the serving cell). If beam failure is not detected, the WTRU may perform beam failure detection again. If beam failure is detected, the WTRU may determine whether the BFR can be performed via the serving cell. If the BFR can be performed via the serving cell, the BFR may be performed via the serving cell. If the BFR cannot be performed via the serving cell, the WTRU may determine whether the condition(s) are fulfilled for performing BFR via a candidate cell (e.g., an LTM candidate cell). If the conditions are fulfilled for performing BFR via the candidate cell (e.g., the LTM candidate cell), BFR may be performed via the candidate cell (e.g., the LTM candidate cell). If the conditions are not fulfilled for performing BFR via the candidate cell (e.g., the LTM candidate cell), the WTRU may perform re-establishment (e.g., via the serving cell).

A RACH to the PCell may be attempted while selecting the suitable beams on the candidate cells or a determination may be made beforehand. For example, RACH may be tried blindly to one of the candidate cells.

Beam failure recovery may be implemented using resources across multiple serving/non-serving cells.

In some examples (e.g., if a WTRU initiates random access procedure for BFR and the WTRU is configured with sets of resources for candidate beams in serving cell and neighbor cells), a WTRU may select a resource from the union of one or more sets of resources based on measurement results (e.g., SS-RSRP or CSI-RSRP) and at least one set-specific and/or cell-specific parameter supporting prioritization between resources. A set-specific parameter may be configured as part of a set-specific BFR configuration. The at least one set-specific parameter may be referred to as “prioritization parameter(s)” herein.

The at least one set-specific parameter may include one or more of: at least one measurement threshold, such as an RSRP threshold; at least one priority level, which may be configured explicitly or may be implicitly determined by a property of the set, such as whether the set includes one or more resources of the serving cell or of a neighbor (e.g., non-serving) cell; or at least one offset applicable to measurement results of resources within the set.

Resource selection may occur within a union of prioritized sets (e.g., a determination of prioritized sets).

In examples, a WTRU may select a resource within the union of prioritized set(s) of resources. A WTRU may determine whether a set is prioritized or not based on one or more (e.g., a combination) of at least one of the following conditions or criteria. A set of resources may be prioritized if (e.g., for at least one resource of the set) the measurement result is above a configured threshold applicable to the set. The WTRU may determine that one or more configured sets (e.g., all configured sets) may be prioritized based on the condition if the condition is not met for any set of resources. A set of resources may be prioritized if its priority level is the maximum priority level among sets that satisfy other conditions for being prioritized.

Resource selection may occur within a union of prioritized sets (e.g., a determination of a resource).

A WTRU may select a resource (e.g., within the union of prioritized sets) that satisfies a criterion among at least one of the following: a resource that maximizes (e.g., or minimizes) a measurement result, such as SS-RSRP or CSI-RSRP; or a resource that maximizes (e.g., or minimizes) the difference between the measurement result and the measurement threshold applicable to the set of resources to which the resource belongs.

In examples, a measurement result for a resource may be adjusted by an offset applicable to the resource and/or to the set of resources to which the resource belongs.

One or more sets of resources for neighbor cell may be up-prioritized if RSRP is above threshold in serving cell.

In examples, a WTRU may adapt at least one set-specific parameters based on whether a measurement result, such as RSRP for a resource within the set of resources for a serving cell, is above a threshold, which may be referred to as a “high RSRP threshold” herein. A high RSRP threshold may be distinct from a threshold configured for prioritization of a set of resources (e.g., as described herein). A high RSRP threshold may be configured by RRC.

A WTRU may determine (e.g., first determine) the highest (e.g., or lowest) RSRP of a resource within the set of resources for the serving cell if the WTRU selects a resource for BFR. Such a value may be referred to as the serving cell RSRP. The WTRU may (e.g., may then) apply, for at least one set of resources, a first set of prioritization parameters if the serving cell RSRP is below the high RSRP threshold, and a second set of prioritization parameters if the serving cell RSRP is above the high RSRP threshold.

For example, a first set of prioritization parameters may correspond to the set of resources corresponding to a serving cell having a higher priority level than other sets of resources, while a second set of prioritization parameters may correspond to sets of resources (e.g., all sets of resources) having same priority level. A WTRU may (e.g., as a result) prioritize resources within the serving cell if a serving cell RSRP is below the high RSRP threshold, and/or prioritize resources within sets (e.g., all sets) including serving cell and neighbor cells if the serving cell RSRP is above the high RSRP threshold.

For example, a first (e.g., or second) set of prioritization parameters may correspond to first (e.g., or second) offset values for sets corresponding to non-serving cells. The first offset values may be higher than second offset values. A WTRU may (e.g., as a result) be more likely to prioritize a resource within a non-serving cell if the serving cell RSRP is above the high RSRP threshold.

This adaptation may allow the WTRU to select a resource from a non-serving cell if the radio link problems are caused by high interference in the serving cell, which may be indicated by the high RSRP in serving cell.

Recovery resources across multiple cells may be used if a BFD is re-detected soon after an earlier BFR.

In examples, a WTRU may adapt at least one set-specific parameter that may be used for selection of a resource within sets of resources based on whether a BFD occurs more than a certain time since BFR was last executed. This adaptation may enhance the robustness of a WTRU link if link problems are caused by interference issues that are difficult to detect from RSRP measurements alone.

A WTRU may start or restart a timer (e.g., referred to as BFR supervision timer) at a stage of a BFD/BFR procedure, such as when one or more of the following occurs: the WTRU detects beam failure; the WTRU initiates a BFR procedure; the WTRU transmits a BFR MAC CE; or the WTRU (e.g., successfully) completes a BFR procedure.

A WTRU may receive the value of a BFR supervision timer, for example, from RRC or MAC signaling.

A WTRU may if the WTRU selects a resource for BFR, apply (e.g., for at least one set of resources), a first set of prioritization parameters if the BFR supervision timer is not running or expired, and a second set of prioritization parameters if the BFR supervision timer is running.

For example, a first set of prioritization parameters may correspond to a set of resources corresponding to a serving cell having a higher priority level than other sets of resources, while a second set of prioritization parameters may correspond to sets of resources (e.g., all sets of resources) having the same priority level. A WTRU may (e.g., as a result) prioritize resources within the serving cell if the BFR was not recently triggered (e.g., within the duration of the BFR supervision timer), and/or prioritize resources within (e.g., all) sets (e.g., including serving cell and neighbor cells) if the BFR was recently triggered.

For example, a first (e.g., or second) set of prioritization parameters may correspond to first (e.g., or second) RSRP threshold values for sets corresponding to non-serving cells. The first RSRP threshold values may be higher than second RSRP threshold values. For example, a first (e.g., or second) set of prioritization parameters may correspond to first (e.g., or second) offset values for sets corresponding to non-serving cells. The first offset values may be higher than the second offset values. The WTRU may (e.g., as a result) expand the number of sets of resources for which BFR is possible.

A failure to send a MAC CE may result in one or more actions. One or more actions may be taken if the RACH fails (e.g., where the recovery is done via the PCell and/or via a candidate cell).

A WTRU may attempt to perform BFR and/or random access on a candidate cell (e.g., and/or a candidate beam) as a fallback attempt if BFR was not successful on the current serving cell (e.g., the cell in which the beam failure was detected and/or triggered). In examples, a WTRU may be configured with one or more (e.g., a number of) transmission attempts to perform BFR RA (e.g., a number of preamble transmission attempts using configured BFR resources) on the serving cell. A WTRU may attempt to perform recovery actions (e.g., BFR) on a candidate cell and/or beam based on meeting and/or exceeding a configured number of BFR attempts.

A candidate cell and/or beam may be used for beam failure recovery based on satisfaction of one or more of the following conditions: an explicit configuration (e.g., the candidate cell and/or beam has been configured as being valid for a fallback BFR attempt); satisfaction of measurement and or quality thresholds (e.g., the candidate beam is equal to or above a measurement and/or quality); the frequency range the candidate cell and/or beam operates on (e.g., the candidate cell may operate on the same frequency range and/or within an offset of the current serving cell); the next occasion to perform RACH on the candidate cell is within the indicated backoff time; whether the current serving cell is the PCell; or whether resources for the BFR have been provided and/or configured for a candidate cell.

In examples, a WTRU may attempt BFR and/or random access on a candidate cell and/or beam based on a re-direction indication by the current serving cell. An indication may indicate (e.g., explicitly indicate) the identity of a candidate cell to attempt a fallback BFR and/or a flag which may indicate that the WTRU may not be able to continue with a BFR procedure on the current cell and should fallback to another cell. A WTRU may (e.g., in this case) attempt a fallback BFR procedure on the candidate cell (e.g., if only one candidate cell is valid and/or has been indicated to the serving cell) and/or the WTRU may select among possible candidate cells.

In examples, multiple candidate beams and/or cells may be suitable to attempt a fallback BFR. A WTRU may select between one or more candidates based on at least one of: the best candidate cell (e.g., based on measurements, which may be based on L1 and/or L3 measurements); the cell in which dedicated resources have been provided and/or configured for the BFR; an explicit indication by the current serving cell; or which candidate cell has the nearest opportunity to perform RACH.

A WTRU may, based on an attempt of BFR to the current serving cell, receive an indication (e.g., implicit indication) to re-direct to a candidate cell. An indication may be based on a backoff indication received during a RA attempt to the current serving cell. A WTRU may attempt RA on a candidate cell and/or candidate beam if the backoff attempt meets one or more criteria. Criteria may include one or more of the following: if the backoff indication is the same as one or more possible back off indicated values (e.g., if BI value equals X); if the backoff indication falls within a range of values (e.g., X<BI<Y); if the BI exceeds and/or falls below a threshold (e.g., BI>X, or BI<Y); or if the nearest suitable RACH occasion falls within the indicated backoff time.

A WTRU may (e.g., may be able to) interpret a BI indication as an indication to attempt BFR on a candidate cell and/or beam based on whether the WTRU has previously indicated and/or provided information regarding candidate cells and/or beams (e.g., via inclusion of candidate beams within a previous report).

A WTRU may cancel an ongoing BFR random access attempt to the current serving cell if the WTRU attempts a fallback BFR on a candidate serving cell and/or beam. The WTRU may cancel the attempt based on reception of RAR from the candidate cell. A WTRU may declare RLF if the WTRU is unable to complete the fallback BFR procedure on the candidate cell (e.g., if the number of fallback attempts exceeds a configured number).

A WTRU may start a timer based on triggering a fallback BFR to a non-serving cell. A WTRU may attempt BFR on one or more candidate non-serving cells while the timer is running. A WTRU may (e.g., based on or when the timer expires) cancel an ongoing BFR-related random access attempt (e.g., if any) and declare RLF.

A CHO may be triggered due to a BFD.

An indication may be provided to the network that the CHO is being triggered due to a BFD. For example, a BFR MAC CE may be sent during the CHO execution (e.g., including information in the HO complete message, etc).

A WTRU may be configured to trigger a CHO and/or evaluate CHO conditions on a candidate cell based on a BFD on the source cell. Information may be provided to the network in the BFR MAC CE and/or in a CHO complete message. A WTRU may execute a CHO command after (e.g., only after) transmitting a (e.g., an enhanced/new) BFR MAC CE, after receiving a response from the network following the transmission of the MAC CE (e.g., msg4, HARQ feedback for the HARQ process on which the MAC CE was transmitted), and/or after a BFR response (e.g., RAR) received on a recovery search space.

One or more actions may be taken before BF is declared. A WTRU may start one or more (e.g., beam) measurements on one or more candidate cells (e.g., or “step up” the measurements) if the number of BFIs is n, where n may be smaller than the max BFI limit to declare BF.

A simplified BFD may be implemented on a candidate cell.

A WTRU may perform a BFD, a beam management process, and/or a modified or simplified BFD on a neighboring cell (e.g., a candidate cell, a CHO candidate, and/or an equivalent cell). A WTRU may be configured with one or more BFD parameters for a candidate cell (e.g., including CSI-RS and/or SSBs to monitor, Qin thresholds, etc.). A configuration may be provided to a WTRU by a (e.g., dedicated) RRC configuration from the source and/or target cells. A WTRU may be configured with a second Qin threshold (e.g., less than the BFD Qin threshold), which the WTRU may use for a BFD if the cell is not yet the serving cell. A WTRU may switch to using a first Q_{in, BFD} threshold if the serving cell becomes the serving cell (e.g., after successful completion of an RA performed on the candidate cell and/or after completing a handover procedure to the cell). A WTRU may add a negative offset to the Q_{in, BFD} threshold configured for the candidate cell if the cell is not a serving cell.

A WTRU may determine a BFD configuration of a neighbor candidate cell from that of the source cell. A WTRU may reuse one or more configurations for one or more conditions (e.g., for an equivalent neighboring cell). A WTRU may acquire a delta configuration for a BFD at the target cell, which may be determined from a broadcast configuration and/or by dedicated delta signaling.

A WTRU may (e.g., for a simplified BFD) maintain a BFI counter (e.g., an additional BFI counter) and BFD timer. A WTRU may start a BFD on a candidate cell based on one or more of the following: detecting BFD on the source cell, starting a recovery procedure on the source cell, evaluating a CHO condition on the candidate cell, measuring a beam on the candidate cell with a channel measurement above a threshold, not measuring a single beam on the source cell with a channel measurement above a threshold, measuring a beam on the candidate cell with a channel measurement with a margin above the best beam measured on the source cell, measuring an L3 measurement (e.g., SS-RSRP) associated with the candidate cell above a threshold, measuring an L3 channel measurement difference between the source and candidate cell above a threshold, meeting an A3 or A5 event threshold for mobility, measuring a difference in channel conditions above a threshold (e.g., within a period of time that is configured or predetermined), or based on reception of an indication (e.g., from the serving cell, including a DCI or MAC CE) to start such BFD/measurement on the candidate cell, where the indication may be related to explicit signaling, NES state switch signaling, and/or L1/L2 mobility signaling.

A simplified BFD procedure may be used to determine whether a WTRU should preform mobility to a cell, execute a CHO command, and/or whether to perform a recovery or reporting procedure on the cell for a BFD detected on another cell. For example, a WTRU may not execute a CHO if a BFI from the candidate cell is observed, if the BFD timer on the candidate cell is running, and/or if a number of BFIs are counted. A WTRU may use a simplified BFD process to determine whether to report and/or recover from a BFD detected on the source cell. A WTRU may report (e.g., using the enhanced BFR MAC CE) and/or recover a BFD detected on the source cell using the candidate cell (e.g., as described herein) if a BFI is not observed on the candidate cell and/or a BFD timer associated with the candidate cell is not running.

A WTRU may be configured with a BFD and/or BFR parameter set to apply in one or more NES states. A WTRU may determine to skip a BFD measurement if the measured SINR or BLER is below a configured threshold.

Although features and elements described above are described in particular combinations, each feature or element may be used alone without the other features and elements of the preferred embodiments, or in various combinations with or without other features and elements.

Although the implementations described herein may consider 3GPP specific protocols, it is understood that the implementations described herein are not restricted to this scenario and may be applicable to other wireless systems. For example, although the solutions described herein consider LTE, LTE-A, New Radio (NR) or 5G specific protocols, it is understood that the solutions described herein are not restricted to this scenario and are applicable to other wireless systems as well.

The processes described above may be implemented in a computer program, software, and/or firmware incorporated in a computer-readable medium for execution by a computer and/or processor. Examples of computer-readable media include, but are not limited to, electronic signals (transmitted over wired and/or wireless connections) and/or computer-readable storage media. Examples of computer-readable storage media include, but are not limited to, a read only memory (ROM), a random access memory (RAM), a register, cache memory, semiconductor memory devices, magnetic media such as, but not limited to, internal hard disks and removable disks, magneto-optical media, and/or optical media such as compact disc (CD)-ROM disks, and/or digital versatile disks (DVDs). A processor in association with software may be used to implement a radio frequency transceiver for use in a WTRU, terminal, base station, RNC, and/or any host computer.

1-14. (canceled)

15. A wireless transmit/receive unit (WTRU), the WTRU comprising:
a processor configured to:
receive configuration information that indicates an L1/L2 mobility (LTM) candidate configuration and a beam failure recovery (BFR) configuration, wherein the LTM candidate configuration indicates an LTM candidate cell;
receive a configuration of at least one condition to perform BFR via the LTM candidate cell;
detect a serving cell beam failure;
based on the detection of the serving cell beam failure, determine whether the at least one condition to perform BFR via the LTM candidate cell is fulfilled; and
perform BFR via the LTM candidate cell based on the at least one condition being fulfilled.

16. The WTRU of claim 15, wherein the at least one condition to perform the BFR via the LTM candidate cell comprises the BFR being unavailable via a serving cell.

17. The WTRU of claim 16, wherein the BFR being unavailable via the serving cell comprises the serving cell having no suitable beam.

18. The WTRU of claim 15, wherein the at least one condition to perform BFR via the LTM candidate cell comprises a measurement of a beam detected on the LTM candidate cell being above a threshold or the measurement of the beam detected on the LTM candidate cell having better radio conditions than a best beam on a serving cell.

19. The WTRU of claim 15, wherein the BFR configuration indicates a resource associated with the LTM candidate cell.

20. The WTRU of claim 19, wherein the BFR performed via the LTM candidate cell comprises a random-access procedure being started towards the LTM candidate cell using the resource associated with the LTM candidate cell.

21. The WTRU of claim 20, wherein the BFR performed via the LTM candidate cell further comprises a BFR MAC CE being sent with information that indicates a best beam of the LTM candidate cell.

22. The WTRU of claim 15, wherein the processor is further configured to perform a measurement on a beam of the LTM candidate cell based on a beam failure detection (BFD) counter being above a threshold.

23. A method implemented in wireless transmit/receive unit (WTRU), the method comprising:
receiving configuration information that indicates an L1/L2 mobility (LTM) candidate configuration and a beam failure recovery (BFR) configuration, wherein the LTM candidate configuration indicates an LTM candidate cell;
receiving a configuration of at least one condition to perform BFR via the LTM candidate cell;
detecting a serving cell beam failure;
based on the detection of the serving cell beam failure, determining whether the at least one condition to perform BFR via the LTM candidate cell is fulfilled; and
performing BFR via the LTM candidate cell based on the at least one condition being fulfilled.

24. The method of claim 23, wherein the at least one condition to perform the BFR via the LTM candidate cell comprises the BFR being unavailable via a serving cell.

25. The method of claim 24, wherein the BFR being unavailable via the serving cell comprises the serving cell having no suitable beam.

26. The method of claim 23, wherein the at least one condition to perform BFR via the LTM candidate cell comprises a measurement of a beam detected on the LTM candidate cell being above a threshold or the measurement of the beam detected on the LTM candidate cell having better radio conditions than a best beam on a serving cell.

27. The method of claim 23, wherein the BFR configuration indicates a resource associated with the LTM candidate cell.

28. The method of claim 27, wherein the BFR performed via the LTM candidate cell comprises a random-access procedure being started towards the LTM candidate cell using the resource associated with the LTM candidate cell.

29. The method of claim 28, wherein the BFR performed via the LTM candidate cell further comprises a BFR MAC CE being sent with information that indicates a best beam of the LTM candidate cell.
